(19) United States
(12) Patent Application Publication
(10) Pub. No.: US 2026/0322499 A1
(43) Pub. Date: Oct. 15, 2026

(54) BLIND TIMING RECOVERY FOR LASER PHASE NOISE INDUCED EQUALIZATION-ENHANCED PHASE NOISE

(71) Applicant: Marvell Asia Pte Ltd, Singapore (SG)

(72) Inventors: Hai Xu, Dublin, CA (US); Shih Cheng Wang, Cupertino, CA (US)

(73) Assignee: Marvell Asia Pte Ltd, Singapore (SG)

(21) Appl. No.: 19/642,816

(22) Filed: Apr. 9, 2026

Related U.S. Application Data
(60) Provisional application No. 63/786,261, filed on Apr. 9, 2025.

(51) Int. Cl. H04B 10/61; H04B 10/40

(52) U.S. Cl. CPC H04B 10/6165; H04B 10/40; H04B 10/6161

(57) ABSTRACT

Equalization-enhanced phase noise (EEPN) imposes timing jitter in coherent optical receivers due to the interaction of laser phase noise with chromatic dispersion (CD) equalization. Conventional timing recovery relies on feedback loops whose bandwidth is fundamentally constrained by implementation latency, limiting their effectiveness against EEPN-induced jitter. To address this, a blind, feedforward timing recovery scheme can be implemented, where a bank of timing shift filters generates parallel candidate signals at different timing offsets, and a signal quality metric is evaluated per candidate to select the optimal timing path. The scheme eliminates the latency bottleneck inherent to feedback-based timing recovery, enabling robust jitter compensation under realistic implementation constraints. Furthermore, the filter bank can support programmable delay grids and selective path activation based on estimated chromatic dispersion, enabling power-efficient operation across varying link distances.

### PRIORITY APPLICATION

This patent application claims priority to and/or receives benefit from U.S. Provisional Application No. 63/786,261, titled “Feedforward Timing Recovery for Laser Phase Noise induced Equalization Enhanced Phase Noise (EEPN)”, filed on Apr. 9, 2025 (Ref. No. MP14518PR). The U.S. Provisional Application is hereby incorporated by reference in its entirety.

### BACKGROUND

High-speed, high-bandwidth communication systems are integral to modern computing and networking applications. These systems are designed to facilitate efficient and reliable data transmission over various media, including optical fibers, copper cables, and wireless channels. Advances in communication technologies, such as signal modulation, equalization, error correction, and clock recovery, can ensure data integrity, reduce latency, and maintain synchronization across devices.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an example electronics system, according to some examples of the disclosure.

FIG. 2 illustrates an implementation of a digital signal processor, according to some examples of the disclosure.

FIG. 3 illustrates an implementation of a digital signal processor having blind timing recovery, according to some examples of the disclosure.

FIG. 4 illustrates an implementation of blind timing recovery, according to some examples of the disclosure.

FIG. 5 illustrates an implementation of signal quality assessment, according to some examples of the disclosure.

FIG. 6 illustrates an implementation of a digital signal processor having blind timing recovery, according to some examples of the disclosure.

FIG. 7 illustrates an implementation of blind timing recovery with selectable delay paths, according to some examples of the disclosure.

FIG. 8 illustrates an implementation of blind timing recovery with programmable delay paths, according to some examples of the disclosure.

FIG. 9 illustrates an implementation of blind timing recovery with programmable delay paths and curve-fitting, according to some examples of the disclosure.

FIG. 10 illustrates curve-fitting utilizing three delay paths, according to some examples of the disclosure.

FIG. 11 depicts a flow chart illustrating a method for blind timing recovery for laser phase noise induced equalization-enhanced phase noise, according to some examples of the disclosure.

FIG. 12 depicts a flow chart illustrating a method for blind timing recovery for laser phase noise induced equalization-enhanced phase noise, according to some examples of the disclosure.

FIG. 13 depicts a flow chart illustrating a method for blind timing recovery for laser phase noise induced equalization-enhanced phase noise, according to some examples of the disclosure.

FIG. 14 depicts a flow chart illustrating a method for blind timing recovery for laser phase noise induced equalization-enhanced phase noise, according to some examples of the disclosure.

### DETAILED DESCRIPTION

### Overview

Coherent optical communication systems achieve high spectral efficiency by encoding information on both the amplitude and phase of an optical carrier. However, this sensitivity to phase makes coherent receivers susceptible to laser phase noise, which manifests as random fluctuations in the instantaneous frequency of the local oscillator (LO) laser. While phase noise has been recognized as a performance-limiting factor in coherent systems, its interaction with the chromatic dispersion (CD) equalizer in the digital signal processor (DSP) gives rise to a particularly problematic degradation mechanism known as EEPN.

As used herein, a “coherent” optical communication system refers to a system in which information is encoded on both the amplitude and phase of an optical carrier, enabling the use of spectrally efficient modulation formats such as quadrature phase-shift keying (QPSK) and quadrature amplitude modulation (QAM). In contrast to direct-detection systems that recover only optical intensity, coherent receivers are sensitive to the phase of the received optical signal, which makes them susceptible to phase noise introduced by the transmitter laser.

EEPN arises because the CD equalizer in the coherent DSP receiver effectively “enhances” the impact of LO laser phase noise. Two degradations arise from EEPN, including additional phase noise and EEPN-induced timing jitter.

Laser frequency noise components at higher frequencies satisfying

$$f \geq \frac{1}{C D \times B W}$$

contribute additional phase noise that is difficult to compensate, for which linewidth can be a reasonable metric. f represents the Fourier frequency of the laser frequency noise, e.g., the frequency at which the power spectral density (PSD) of the laser's frequency fluctuations is evaluated. CD represents the total accumulated chromatic dispersion of the optical fiber link, e.g., expressed in units of ps/nm or ns/nm. CD characterizes how much different frequency components of the optical signal are delayed relative to one another as they propagate through the fiber. The larger the CD (i.e., the longer the fiber or the higher the dispersion coefficient), the more severe the EEPN interaction. BW represents the signal bandwidth processed by the chromatic dispersion equalizer in the DSP, e.g., the baud rate or symbol rate bandwidth of the received signal. BW sets the frequency scale over which the CD equalizer operates, and together with CD, BW defines the boundary frequency that separates the “extra phase noise” regime from the “timing jitter” regime.

Timing jitter can arise from components satisfying both

$$f ≪ \frac{1}{C D \times B W} and f > \frac{1}{TR\_BW} .$$

TR_BW represents the closed-loop bandwidth of the timing recovery (TR) feedback loop. TR_BW represents how fast the timing recovery loop can respond to and track changes in timing/phase. These components, e.g., components at lower frequencies and components that exceed the bandwidth of the timing recovery loop, introduce timing jitter that the timing recovery loop cannot track, resulting in a direct performance penalty and residual timing jitter. Notably, there is no penalty from these components if the timing recovery loop is fast enough to track them. This means that timing recovery loop bandwidth, and thus latency, represents the central bottleneck. As symbol rates increase and symbol periods shrink, tracking becomes increasingly difficult, and significant 1/f laser noise in this frequency region makes laser linewidth alone an insufficient predictor of system degradation. The impact is particularly severe in long-haul transmission, where accumulated CD amplifies the interaction and imposes stringent laser phase noise specifications that significantly increase the cost of coherent optical modules.

Some coherent DSP receivers employ a timing recovery feedback loop to reduce clock jitter in the received signal. The feedback loop may include a timing error detector (TED), a loop filter, and a timing adjustment block. The amount of residual jitter is inversely proportional to the TR loop bandwidth, which is in turn fundamentally limited by the latency of the feedback path. In practical DSP implementations, circuit timing constraints, pipeline stages, and clock alignment requirements impose a minimum-latency floor that caps the achievable loop bandwidth. Consequently, even an aggressively optimized feedback TR loop cannot track the rapid timing variations introduced by EEPN, leaving a residual jitter floor that degrades bit-error rate (BER) performance, particularly under high CD and poor laser linewidth conditions.

To overcome the latency bottleneck of feedback-based timing recovery, a blind, feedforward timing recovery scheme can be implemented. The approach involves “blind timing search” or “blind timing recovery” to generate multiple candidate versions of the received signal, each corresponding to a different candidate timing offset. Then, a signal quality metric for each candidate can be evaluated to identify and select the optimal timing path. Because this selection process does not depend on a closed feedback loop, it is not subject to loop latency constraints, enabling rapid adaptation to EEPN-induced timing variations without requiring unrealistically fast loop dynamics.

As used herein, the term “blind” in blind timing recovery or blind timing search refers to a timing recovery or search approach that does not rely on a closed feedback loop driven by a timing error estimate derived from a decision-directed or data-aided process. Instead, blind timing recovery or blind timing search evaluates a plurality of candidate timing offsets in parallel and selects an optimal timing path based on a signal quality metric, without requiring the selected timing offset to be tracked iteratively through a feedback mechanism. The term “blind” further connotes that the timing search is performed without prior knowledge of the correct timing offset, relying solely on the signal quality metric evaluated across the candidate paths to identify the optimal correction. This distinguishes the blind, feedforward architecture described herein from other timing recovery feedback loops, which converge on a timing estimate through iterative error correction subject to loop bandwidth and latency constraints.

The proposed blind, feedforward architecture comprises one or more components: a bank of time shifting filters, a signal quality metric computation stage, and a path selector. The filter bank generates a plurality of candidate signals by applying different timing offsets to the input signal. In some examples, the number of filters and/or their spacing are configurable parameters. A candidate signal is evaluated by the metric computation stage, and the path selector outputs the candidate signal with the best signal quality metric for further processing. In some examples, in the frequency domain, each time-shift operation reduces to a multiplication by a corresponding phase mask, to provide a computationally efficient implementation.

The placement of this filter bank within the DSP chain is flexible. The different placements involving different points within the coherent DSP processing chain can offer distinct trade-offs. In some examples, the filter bank and the path selector may be positioned at the output of the DSP back end. The filter bank and the path selector operate on fully equalized signals and leverage slicer-based mean-square error (MSE). In some examples, the filter bank and the path selector may be positioned between the DSP front end and back end. The filter bank and the path selector leverage metric computation performed using the timing error detector of the existing timing recovery loop, thereby using existing loop infrastructure while eliminating its latency dependence. Moreover, the filter bank and the path selector can correct for EEPN earlier on in the processing chain, which can allow subsequent DSP back end blocks or other blocks downstream to process a signal with lower jitter. In some examples, the filter bank and the path selector may be positioned at the output of a least-means-squared stage feeding back into the DSP back end. The filter bank and path selector enable timing correction prior to final back end processing.

In some examples, the signal quality metric includes the mean-square error computed relative to sliced symbol decisions. For each candidate path, an error signal is formed as the difference between the candidate signal samples and their corresponding sliced decisions. The MSE can then be computed over a window of symbols. In some examples, the metric is computed over 80 symbols per-filter-path per-clock and is optionally averaged over 5 clocks before path comparison and selection. The candidate path yielding the best signal quality metric, e.g., having the minimum MSE, is selected for output. Notably, MSE is one example of a signal metric. It is envisioned that one or more signal metrics that indicate signal quality may be substituted. While slicer-based MSE is effective, MSE calculation uses symbol decisions from the DSP back end, which may introduce additional latency.

As used herein, the term “symbol” refers to a discrete unit of modulated data transmitted over the optical link, corresponding to a point in a signal constellation defined by the modulation format (e.g., quadrature amplitude modulation or phase-shift keying (PSK)). Each symbol encodes one or more bits of information through its amplitude and/or phase. A “sliced symbol,” also referred to as a hard-decision symbol, is a quantized estimate of a received symbol produced by a slicer that maps the received signal sample to the nearest point in the signal constellation. The term “recovered symbols” refers to the output of DSP back end 210 after back end processing operations, including carrier recovery and equalization, have been applied to the received digital signal. Recovered symbols 292 represent the DSP's best estimate of the transmitted symbol sequence prior to any timing correction applied by blind timing recovery 302. In some examples, sliced symbols and recovered symbols may be used interchangeably where context permits, as both represent hard-decision outputs relative to the signal constellation.

In some examples, the signal quality metric includes timing error computed using TEDs that do not use sliced symbols, e.g., non-decision-directed or non-data-aided TEDs. The TED output for each candidate timing path can serve directly as the signal quality metric, with the path exhibiting the minimum timing error magnitude selected as optimal. The use of non-decision-directed TEDs enables metric computation earlier in the DSP processing chain, reducing latency and allowing the timing-selection block to be positioned between the DSP front end and back end, providing jitter correction benefit to all subsequent processing stages.

In some examples, an implementation employing 21 timing shift filters spanning ±0.1 unit interval (UI) in steps of 0.01 UI with 7-tap filters demonstrated near-ideal performance. In some examples, reducing the filter bank to as few as three filters at offsets of −0.05, 0, and +0.05 UI with 5-tap filters achieved performance comparable to the best-case limit of other timing recovery solutions, at a fraction of the complexity. In some examples, further reduction to 3-tap filters exhibited some measurable degradation. Various findings suggest that the blind, feedforward timing recovery approach achieves substantial performance gains over other feedback timing recovery with minimal additional hardware complexity, making it well-suited for integration into practical coherent DSP implementations.

As used herein, a “UI refers to the duration of one symbol period, e.g., the reciprocal of the baud rate or symbol rate of the received signal. A timing offset expressed in units of UI is therefore a normalized measure of timing displacement relative to the symbol period, where an offset of 1.0 UI corresponds to a full symbol period of delay or advance. Expressing timing offsets in UI allows performance specifications to be stated independently of the absolute baud rate, facilitating comparison across different data rate configurations.

In some examples, the timing offsets in the filter bank need not be uniformly spaced or fixed. The blind, feedforward timing recovery architecture supports a programmable delay grid in which one or more of the number of candidate paths, their spacing, and their range are configurable, e.g., via control signals and/or firmware-accessible registers.

In some examples, to further reduce complexity and power consumption while maintaining accuracy, the filter bank can be operated with a sparse set of timing offsets, and the signal quality metrics evaluated at those sparse points can be fitted to a curve to analytically estimate the optimal timing offset. This curve-fitting approach, illustrated with a parabolic fit over the metric-versus-offset profile, enables fine-grained timing estimation without using a large number of densely spaced filters, effectively decoupling timing resolution from filter bank size. One of the candidate paths can be programmed to apply the optimal timing offset.

In some examples, the blind, feedforward timing recovery architecture can be adapted to implement power-efficient and/or link-adaptive operation. Because the magnitude of EEPN-induced timing jitter scales with chromatic dispersion and thus with link length, the number of candidate paths that are enabled and evaluated can vary with the operating scenario. In low-CD environments, such as short-reach links, a reduced number of candidate paths near zero offset can be enabled while remaining filter paths may be clock-gated and/or power-gated to conserve power. Conversely, in high-CD, long-haul scenarios, a larger search range and more candidate paths can be activated. The estimated or expected CD can be readily available from the electrical CD compensation (ECD) stage already present in the DSP front end, which can be used to generate a control signal for configuring the delay grid and/or activating the appropriate subset of filter paths. This adaptive strategy enables seamless operation across varying link distances and accommodates traffic-driven route changes that alter the effective transmission distance.

The blind, feedforward timing recovery architecture advantageously lacks a feedback loop. Therefore, the architecture has the ability to tolerate sudden changes in clock jitter and is not limited by feedback loop bandwidth or latency. The architecture can effectively be used in tracking timing jitter and enable low-cost lasers to be used in pluggable coherent optical modules for long-distance transmissions. The architecture can also be used to reduce the impact of clock jitter from the transmit side clock and the receive side clock.

Experimental validation using an offline DSP processing framework based on a 5 nm 800 Gbps coherent DSP platform confirms that the blind, feedforward scheme substantially outperforms other feedback timing recovery solutions under realistic implementation latency constraints and achieves performance approaching the theoretical minimum-latency lower bound of feedback timing recovery. The improvement is most pronounced under high-CD and high laser phase noise conditions. These conditions represent the operating regime targeted by emerging ZR+ and OpenROADM standards, which mandate long-haul transmission using low-cost, pluggable coherent optical modules. Beyond EEPN compensation, the blind, feedforward timing recovery scheme also provides a benefit in reducing the impact of transmitter and receiver clock jitter more broadly, underscoring its utility as a general-purpose timing robustness mechanism for next-generation coherent optical transceivers.

### Example Communication System

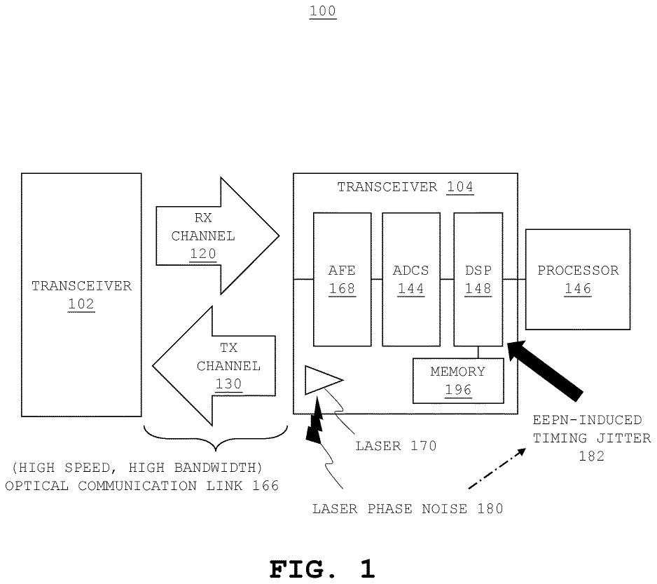

FIG. 1 illustrates an example electronics system 100, according to some examples of the disclosure. Electronics system 100 can be used in high-speed, high-bandwidth communication applications. Electronics system 100 can include one or more components to carry out functionalities, including, among other things, effective signal transmission, reception, diagnostics, and clock recovery functionality. Electronics system 100 includes transceiver 102 and transceiver 104. Transceiver 104 can carry out communication functionalities for processor 146. For simplicity, the processor that transceiver 102 is carrying out communication functionalities for is omitted in the figure.

Processor 146 may perform data processing tasks. Processor 146 can include one or more suitable types of processors, and one or more suitable number of processors. Processor 146 may be a single-core processor, or a multi-core (e.g., ARM or x86 processor cores). Examples of processor 146 may include a central processing unit (CPU), a graphics processing unit (GPU), a field-programmable gate array (FPGA), a tensor processing unit (TPU), a data processing unit (DPU), a microprocessor, a DSP, an application-specific integrated circuit (ASIC), etc. Processor 146 can execute instructions or commands of an operating system. Processor 146 can perform operations and/or computations for an application of electronics system 100. Instructions executable by processor 146 that, when executed by processor 146, can cause processor 146 to perform one or more operations can be stored on memory 196 (e.g., an example of a non-transitory computer-readable medium).

Transceiver 104 can enable transmission and reception of signals over (high-speed, high-bandwidth) communication link 166. In this example, communication link 166 can include one or more of: receive (RX) channel 120 and transmit (TX) channel 130. RX channel 120 can have one or more RX data lanes. Communication link 166 can be a high-speed, high-bandwidth optical communication link. TX channel 130 can have one or more TX data lanes. Herein, transceiver 102 and transceiver 104 are optical transceivers. RX channel 120 can include one or more optical paths or links. TX channel 130 can include one or more optical paths or links.

Transceiver 102 can transmit data over TX channel 130 to transceiver 104 and can include circuitry to support transmission of data. Transceiver 102 can include a laser (not explicitly depicted) to transmit an optical signal over TX channel 130 to transceiver 104. Incoming optical data signals transmitted over RX channel 120 can be received or sensed by transceiver 104, e.g., by an optical sensing module in transceiver 104.

Transceiver 140 can include laser 170. In a coherent optical transceiver (e.g., transceiver 102 or transceiver 140, a single laser output can be split such that a first portion serves as the TX laser to modulate the optical signal for transmission over TX channel 130, and a second portion serves as a local oscillator (LO) that is combined with an incoming optical signal received over RX channel 120 to enable coherent detection of both the amplitude and phase of the received optical signal. For transceiver 140, laser 170 can be used as both the TX laser for transmitting optical signals and the LO for receiving optical signals.

Transceiver 104 has circuitry that processes the received data signals (e.g., signals that are received using laser 170 operating as a LO. Transceiver 104 can include an analog front end (AFE) 168, which may include one or more amplifiers or other analog circuits to process the received data signals before the data signals are provided to analog-to-digital converters (ADCs) 144. ADCs 144 can digitize the analog signals and output digital outputs or digital samples for further processing by DSP 148. For high-speed, high-bandwidth data interfaces, ADCs 144 include time-interleaved ADCs used to sample an analog signal received on RX channel 120 to achieve the baud rate of the communication channel. Time-interleaved ADCs 144 can take turns, one after another, or in a randomized fashion, to sample the received analog signal at different sampling points to produce the digitized samples of the received analog signal.

In some examples, the optical sensing module of transceiver 104 can include one or more photodetectors, such as photodiodes, that convert the received optical signal into an electrical signal for further processing by AFE 168 and ADCs 144. In a coherent optical receiver, the optical sensing module can include a hybrid coupler or optical hybrid that combines the received optical signal with a reference optical signal to produce in-phase (I) and quadrature (Q) components, which are then converted to electrical signals by balanced photodetectors. The optical sensing module is not separately labeled in FIG. 1 for brevity, but represents an optical-to-electrical conversion stage within transceiver 104 disposed between RX channel 120 and AFE 168.

Transceiver 104 can transmit signals to transceiver 102 via TX channel 130, and transceiver 104 can include additional circuitry to prepare data signals to be transmitted over TX channel 130. Transceiver 104 can include TX circuitry to ensure faithful signal transmission over communication link 166.

DSP 148 can manage data processing tasks within transceiver 104. DSP 148 can include circuitry to perform one or more operations or computations. DSP 148 can include circuitry that can execute instructions and carry out one or more operations or computations. Examples of operations or computations can include, but are not limited to, diagnostics, control algorithms, signal processing, filtering, decision making or slicing, and equalization.

Laser 170 can introduce laser phase noise 180 in transceiver 104. Laser phase noise 180 arises from random fluctuations in the phase of the optical carrier emitted by laser 170 and can degrade the quality of the received signal at transceiver 104. In coherent optical communication systems, laser phase noise 180 can interact with chromatic dispersion compensation circuitry or equalization circuitry in DSP 148 to produce EEPN-induced timing jitter 182. EEPN-induced timing jitter 182 is a form of timing jitter introduced at transceiver 104 as a result of the interaction between laser phase noise 180 and the chromatic dispersion equalizer in DSP 148, and represents a source of signal degradation that limits the performance of the communication system, particularly in long-haul transmission over optical paths with significant chromatic dispersion.

As used herein, “laser phase noise” refers to random fluctuations in the instantaneous phase or frequency of the optical carrier emitted by laser 170, which are combined with the received signal in RX channel 120. The interaction of this laser phase noise with the chromatic dispersion equalizer in DSP 148 gives rise to EEPN, as described herein.

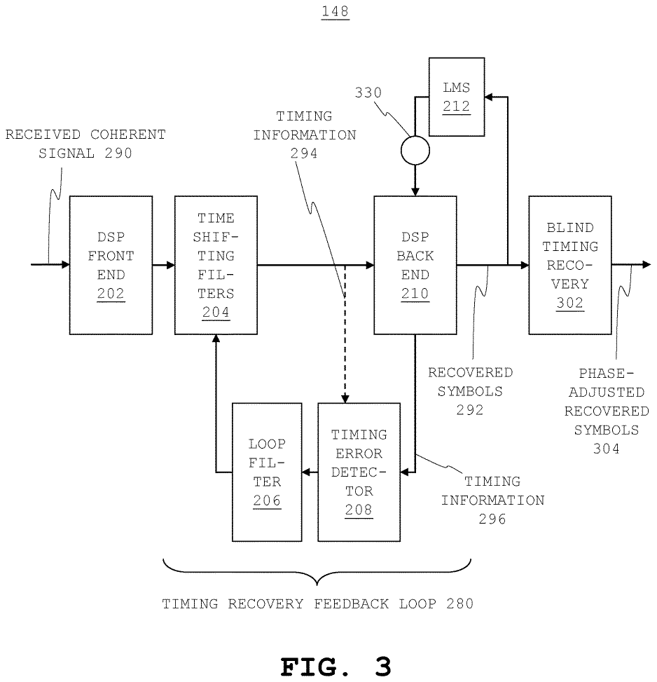

DSP 148 can be subject to EEPN-induced timing jitter 182. EEPN-induced timing jitter 182 results from the interaction of laser phase noise 180 with equalization circuitry in DSP 148, such as a chromatic dispersion equalizer. This interaction can introduce timing jitter into the received digital signal that varies with the chromatic dispersion of the optical path and the phase noise characteristics of laser 170. EEPN-induced timing jitter 182 can be particularly pronounced in high-baud-rate, long-haul coherent optical transmission systems, where chromatic dispersion is significant and the symbol period is short. To address this concern, DSP 148 can include blind timing recovery logic to reduce or compensate for EEPN-induced timing jitter 182, as described in further detail in FIGS. 3-14.

While the description is focused on transceiver 104, it is envisioned that various examples described herein are applicable to transceiver 102. It is also envisioned that various examples described herein are applicable to receivers (receive-only interfaces).

### Example Implementation of a Digital Signal Processing Chain

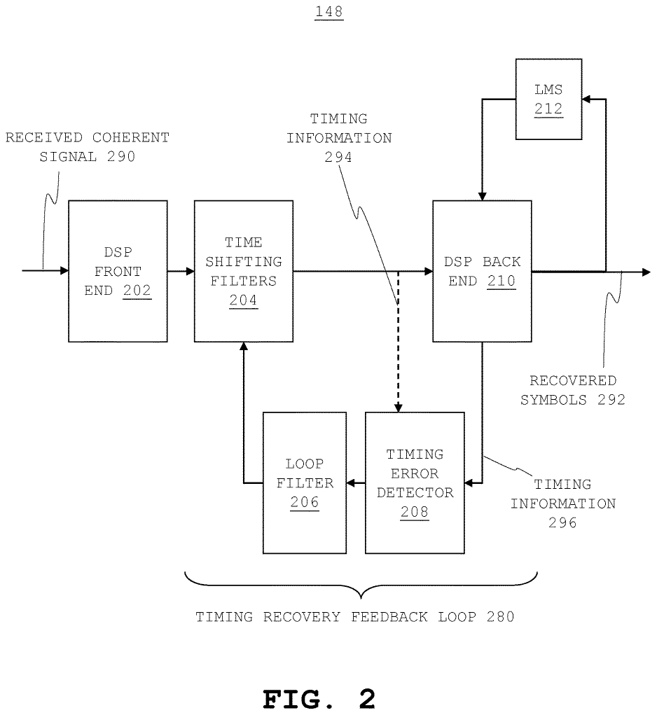

FIG. 2 illustrates an implementation of DSP 148 (e.g., in a transceiver), according to some examples of the disclosure. DSP 148 comprises one or more of: DSP front end 202, time shifting filters 204, loop filter 206, timing error detector 208, DSP back end 210, and least-mean-squared (LMS) equalizer 212. DSP 148 receives received coherent signal 290 and outputs recovered symbols 292.

As used herein, received coherent signal 290 refers to the digitized representation of the optical signal received over RX channel 120, produced by ADCs 144 from the analog electrical signal output by AFE 168 (as illustrated in FIG. 1). Although the term “coherent signal” reflects the coherent optical origin of the signal, received coherent signal 290 as input to DSP 148 is a digital signal comprising one or more streams of digital samples representing the in-phase (I) and quadrature (Q) components of the received optical signal after analog-to-digital conversion. DSP front end 202 receives received coherent signal 290 and performs front end processing operations on the digital samples, as described herein.

DSP front end 202 can receive received coherent signal 290, which is an optical signal received over an optical link and digitized by one or more ADCs 144. DSP front end 202 can perform one or more front end processing operations on received coherent signal 290 to produce a digital signal for further processing. Front end processing operations can include, but are not limited to, one or more of: automatic gain control (AGC), skew compensation, electrical chromatic dispersion (ECD) compensation, feedforward equalization (FFE), and frequency and carrier recovery. DSP front end 202 can output a processed digital signal to time shifting filters 204.

Time shifting filters 204 can receive the processed digital signal output by DSP front end 202 and can apply a timing adjustment to the processed digital signal based on a filtered timing signal received from loop filter 206. Time shifting filters 204 can perform a timing correction to bring the timing of the processed digital signal within an acceptable range, or ballpark, prior to further processing by DSP back end 210.

Timing error detector 208 can receive an output from DSP front end 202 or DSP back end 210 and can determine a timing error of the received signal. Timing error detector 208 can determine a timing error by comparing a received digital signal to an expected or reference signal to estimate a deviation in sampling phase. In some examples, timing error detector 208 can receive timing information 296 from DSP back end 210. Timing information 296 can comprise sliced symbols or other timing-relevant information output by DSP back end 210 and can be used by timing error detector 208 as an input for computing a timing error signal for timing recovery feedback loop 280. In some examples, timing information 296 represents an alternative or supplemental input to timing error detector 208 compared to the input derived from DSP front end 202 or time shifting filters 204, and can enable timing error detector 208 to operate in a decision-directed mode using sliced symbols from DSP back end 210 rather than a non-data-aided mode using the output of DSP front end 202. In some examples, timing error detector 208 can operate using sliced symbols output by DSP back end 210, where a sliced symbol is a hard-decision output representing the nearest constellation point to the received sample. In such examples, timing error detector 208 can compute a timing error by forming an error signal as a difference between the received sample and the sliced symbol, and combining the error signal with a derivative of the received signal to estimate the direction and magnitude of the timing deviation (e.g., employing an approach consistent with a Mueller-Müller or decision-directed timing error detector). In some examples, timing error detector 208 can operate without sliced symbols, using a signal derived directly from the output of DSP front end 202 or the output of time shifting filters 204. In such examples, timing error detector 208 can apply a non-data-aided algorithm, such as a Gardner timing error detector, which estimates the timing error by computing a product of a sample at a midpoint between two successive symbol samples and the difference of those two symbol samples, without requiring knowledge of the transmitted symbol values. Timing error detector 208 can output a timing error signal representing a signed estimate of the sampling phase deviation to loop filter 206 for filtering and noise reduction prior to application to time shifting filters 204.

As used herein, a “timing error detector” is a circuit or computational block that estimates the deviation of the current sampling phase from an optimal sampling phase for the received digital signal. A TED produces a timing error signal representing a signed estimate of this deviation, which can be used to drive a timing correction mechanism. TEDs can be classified as data-aided (decision-directed) or non-data-aided (blind), depending on whether they use knowledge of the transmitted symbol values or hard-decision outputs to compute the timing error. Decision-directed TEDs, such as the Mueller-Müller detector, use sliced symbol decisions to form an error signal and can provide accurate timing estimates when the signal quality is sufficient for reliable slicing. Non-data-aided TEDs, such as the Gardner detector, estimate timing error from the signal samples alone without requiring knowledge of transmitted symbols, making them suitable for use earlier in the DSP processing chain where symbol decisions may not yet be available. In some examples, non-data-aided TEDs can include a frequency-domain based timing error calculator (e.g., mathematically equivalent to the Gardner detector).

Loop filter 206 can receive the timing error signal output by timing error detector 208 and can filter the timing error signal to reduce noise. Loop filter 206 can output a filtered timing signal to time shifting filters 204 to adjust a coarse timing of the processed digital signal.

DSP back end 210 can receive timing information 294 from time shifting filters 204 and can perform one or more back end processing operations on the received digital signal to produce recovered symbols 292. Back end processing operations can include, but are not limited to, one or more of: frequency and carrier recovery (FCR), blind phase search (BPS), post-filtering, forward error correction (FEC) decoding, and BER estimation. FCR can estimate and correct a residual frequency offset between a transmitter laser and a local oscillator laser remaining after front end processing and can track and remove a carrier phase to align a received signal constellation to an expected constellation. BPS can be applied within or alongside FCR to estimate a carrier phase in a non-data-aided manner by testing a plurality of candidate phase rotations applied to the received digital signal, computing a decision metric for each candidate phase rotation, and selecting a candidate phase rotation that minimizes the decision metric. Post-filtering can apply an equalization stage, such as an individual finite impulse response (FIR) filter or a decision-feedback equalizer (DFE), to reduce residual inter-symbol interference (ISI) or noise remaining after front end equalization. BER estimation can compute a running estimate of a bit-error rate of recovered symbols 292, for example by comparing recovered symbols 292 against a known pseudo-random binary sequence (PRBS) pattern or by using FEC syndrome statistics as a proxy metric. DSP back end 210 can output recovered symbols 292 representing decoded data symbols of received coherent signal 290 and can optionally further output sliced symbols to timing error detector 208 and to LMS equalizer 212.

In some examples, LMS equalizer 212 can receive sliced symbols from DSP back end 210 and can apply a LMS adaptation algorithm to adjust one or more filter taps to minimize residual error in the output of DSP back end 210. LMS equalizer 212 can output an equalized digital signal to DSP back end 210. In some examples, LMS equalizer 212 can represent an equalization stage that refines the output of DSP back end 210 by reducing residual inter-symbol interference or other signal impairments remaining after front end and back end equalization.

Time shifting filters 204, DSP back end 210, timing error detector 208, and loop filter 206 collectively form timing recovery feedback loop 280. Timing recovery feedback loop 280 illustrates a feedback-based timing recovery architecture in which the bandwidth of timing recovery feedback loop 280, and thus its ability to track timing jitter induced by EEPN-induced timing jitter 182, is limited by the latency of the feedback path through time shifting filters 204, DSP back end 210, timing error detector 208, and loop filter 206.

In some examples, DSP 148 illustrated in FIG. 2 represents a timing recovery architecture in which timing recovery feedback loop 280 is the primary mechanism for recovering the clock or timing of received coherent signal 290. As mentioned above, the latency inherent in timing recovery feedback loop 280 limits its effectiveness in tracking EEPN-induced timing jitter 182, particularly in high-baud-rate coherent optical communication systems operating over long optical links with significant chromatic dispersion. The blind timing search or recovery logic described in connection with FIGS. 3-14 addresses this limitation by operating in a feedforward manner, without being limited by the feedback latency-constrained path of timing error detector 208 and loop filter 206.

Example Implementations of Improved Digital Signal Processing Chain with Blind, Feedforward Timing Search or Recovery

FIG. 3 illustrates an implementation of DSP 148 (e.g., in a transceiver) having blind timing recovery, according to some examples of the disclosure. In the example illustrated in FIG. 3, blind timing recovery 302 is disposed after DSP back end 210 and receives recovered symbols 292 output by DSP back end 210 as a digital signal. Blind timing recovery 302 can apply a plurality of timing shifts to recovered symbols 292 to generate a plurality of candidate signals, determine a plurality of signal metrics for the plurality of candidate signals, and select a selected candidate signal based on the plurality of signal metrics to output phase-adjusted recovered symbols 304. Phase-adjusted recovered symbols 304 represent recovered symbols 292 with an optimal timing correction applied by blind timing recovery 302 to compensate for EEPN-induced timing jitter 182 as illustrated in FIG. 1.

In some examples, blind timing recovery 302 operates on symbols output by DSP back end 210, such that the plurality of signal metrics can be determined based on a MSE formed between an individual candidate signal and a sliced symbol corresponding to the individual candidate signal.

In some examples, blind timing recovery 302 operates in a feedforward manner, and is outside of timing recovery feedback loop 280. The feedforward architecture of blind timing recovery 302 is thus not subject to the latency constraints of timing recovery feedback loop 280. Timing recovery feedback loop 280, comprising time shifting filters 204, DSP back end 210, timing error detector 208, and loop filter 206, can continue to operate concurrently with blind timing recovery 302 to provide a coarse timing correction to the digital signal prior to DSP back end 210. Blind timing recovery 302 can then apply a fine-grained timing correction to recovered symbols 292 output by DSP back end 210 to further reduce residual EEPN-induced timing jitter 182 as illustrated in FIG. 1, not addressed by timing recovery feedback loop 280. In this manner, timing recovery feedback loop 280 and blind timing recovery 302 can operate in a complementary fashion, with timing recovery feedback loop 280 bringing the timing of received coherent signal 290 into an acceptable range and blind timing recovery 302 performing a blind search over a plurality of candidate timing offsets to identify and apply an optimal timing correction.

In some alternative examples, blind timing recovery 302 can be placed after LMS equalizer 212, e.g., at node 330, rather than after DSP back end 210. In such examples, blind timing recovery 302 can receive an equalized digital signal output by LMS equalizer 212 as the digital signal, and can apply a plurality of timing shifts to the equalized digital signal to generate a plurality of candidate signals, determine a plurality of signal metrics for the plurality of candidate signals, and select a selected candidate signal to be fed to DSP back end 210. In this placement, blind timing recovery 302 operates on an equalized digital signal that has been processed by both DSP back end 210 and LMS equalizer 212, such that residual inter-symbol interference and other signal impairments addressed by LMS equalizer 212 have already been reduced prior to the application of blind timing recovery 302. In some examples, DSP back end 210 can receive a phase-adjusted output from blind timing recovery 302 for further back end processing, such as FEC decoding and BER estimation, based on the selected candidate signal with an optimal timing correction applied to compensate for EEPN-induced timing jitter 182 as illustrated in FIG. 1.

In some examples, blind timing recovery 302 can be placed after LMS equalizer 212, e.g., at node 330, rather than after DSP back end 210. Node 330 represents a signal node in the DSP processing chain of DSP 148 disposed at the output of LMS equalizer 212 and prior to DSP back end 210, such that a signal at node 330 has been processed by both DSP back end 210 and LMS equalizer 212 before being provided to blind timing recovery 302.

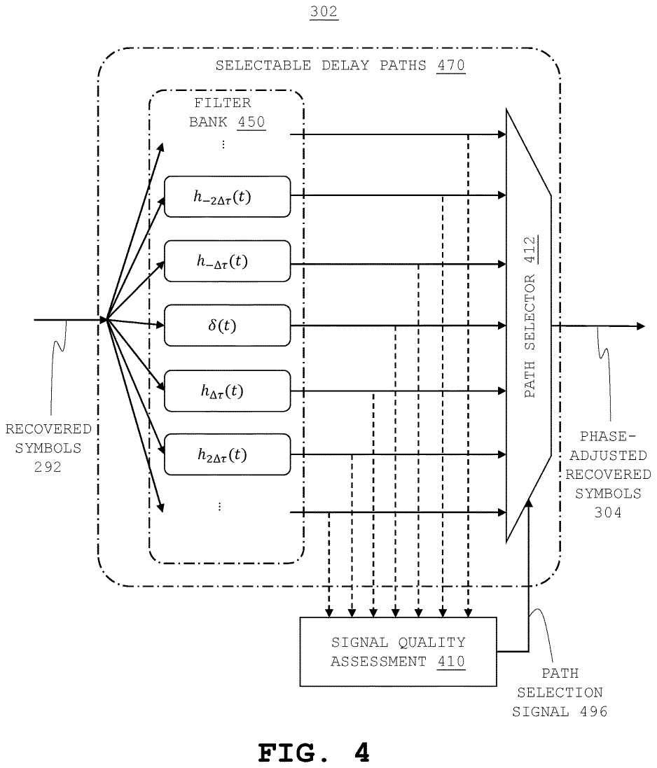

FIG. 4 illustrates an implementation of blind timing recovery 302, according to some examples of the disclosure. Blind timing recovery 302 comprises one or more of: selectable delay paths 470, signal quality assessment 410, and path selector 412. Blind timing recovery 302 receives recovered symbols 292 as a digital signal and outputs phase-adjusted recovered symbols 304, representing recovered symbols 292 with an optimal timing correction applied to compensate for EEPN-induced timing jitter 182 as illustrated in FIG. 1.

Selectable delay paths 470 can comprise a plurality of signal paths, each signal path receiving recovered symbols 292 and applying an individual timing offset to recovered symbols 292 to produce an individual candidate signal. Selectable delay paths 470 comprise filter bank 450 and path selector 412.

Filter bank 450 can include a plurality of timing shift filters. In the example illustrated in FIG. 4, filter bank 450 comprises timing shift filters, e.g., h_{-2Δτ}(t), h_{-Δτ}(t), δ(t), h_{Δτ}(t), and h_{2Δτ}(t), as well as possible additional signal paths indicated by ellipses above and below. Filter bank 450 represents a bank of filters corresponding to a plurality of timing offsets spanning a range of negative and positive timing shifts relative to a reference timing. Timing shift filter δ(t) represents an individual signal path applying a zero timing offset, passing recovered symbols 292 without an additional timing shift. Timing shift filters h_{-2Δτ}(t), h_{-Δτ}(t), h_{Δτ}(t), and h_{2Δτ}(t) each apply an individual negative or positive timing offset that is a respective integer multiple of a timing step Δτ to recovered symbols 292 to produce a respective candidate signal.

In some examples, filter bank 450 can be provided with a number of signal paths, such as 3, 5, 7, 9, 11, or 21 signal paths, depending on a desired tradeoff between timing correction resolution and implementation complexity or power consumption. In some examples, the spacing between individual timing offsets, represented by timing step Δτ, can be uniform or non-uniform across the plurality of signal paths of filter bank 450.

In some examples, one or more signal paths of filter bank 450 can be implemented as one or more FIR filters. An individual signal path can apply an individual set of FIR filter coefficients corresponding to a respective timing offset. The number of taps for the FIR filter can vary depending on a desired tradeoff between timing correction resolution and implementation complexity or power consumption.

In some examples, individual signal paths of filter bank 450 can be implemented in the frequency domain as multiplications by one or more phase masks, where an individual phase mask corresponds to an individual timing offset. The frequency domain implementation can simplify the computation of timing shift filters h_{-2Δτ}(t), h_{-Δτ}(t), h_{Δτ}(t), and h_{2Δτ}(t), as each individual timing shift corresponds to a multiplication by an appropriate phase mask rather than a convolution operation in the time domain.

In some examples, a timing shift applied by an individual signal path of filter bank 450 can be implemented in the frequency domain as a multiplication by a phase mask. A phase mask corresponding to a timing offset τ is a complex exponential function of frequency, expressed as e^{j2πfτ}, where f denotes the frequency variable and τ denotes the timing offset to be applied. Multiplying the frequency domain representation of a signal by this phase mask is equivalent to shifting the signal in the time domain by τ, by virtue of the time-shift property of the Fourier transform. This frequency domain implementation can be computationally advantageous when the signal is already represented in the frequency domain, for example after a fast Fourier transform (FFT) stage, since each timing shift reduces to an element-wise complex multiplication rather than a convolution in the time domain.

Each signal path of selectable delay paths 470 can output an individual candidate signal to both signal quality assessment 410 and path selector 412. Signal quality assessment 410 can receive the plurality of candidate signals output by selectable delay paths 470 and can determine a plurality of signal metrics, where an individual signal metric corresponds to an individual candidate signal and is indicative of a timing correctness or timing error of the individual candidate signal. Signal quality assessment 410 can output path selection signal 496 to path selector 412 based on the plurality of signal metrics, where path selection signal 496 identifies a selected candidate signal among the plurality of candidate signals having a signal metric indicative of a highest signal quality or a lowest timing error among the plurality of candidate signals.

In some examples, signal quality assessment 410 can determine an individual signal metric for an individual candidate signal using one or more of: a MSE computation, or a timing error computation that does not use sliced symbols. Signal quality assessment 410 can compare the plurality of signal metrics across the plurality of candidate signals and output path selection signal 496 identifying a selected candidate signal having a minimum signal metric, in examples where the signal metric represents a timing error or MSE, or a maximum signal metric, in examples where the signal metric represents a signal quality measure.

In examples where signal quality assessment 410 computes an MSE-based signal metric, signal quality assessment 410 can slice an individual candidate signal to generate a sliced symbol representing a nearest constellation point (e.g., 0 or 1), form an error signal as a difference between the individual candidate signal and the sliced symbol, and determine a mean-squared value of the error signal as the signal metric for the individual candidate signal. A candidate signal with a correct or near-correct timing offset would produce a tightly clustered signal constellation and a correspondingly low MSE, while a candidate signal with an incorrect timing offset will produce a spread constellation and a correspondingly high MSE.

In some examples, signal quality assessment 410 can determine a signal metric for an individual candidate signal using a timing error detector that does not use sliced symbols, such as a Gardner timing error detector or another non-data-aided timing error detector. In such examples, signal quality assessment 410 can compute a timing error by applying a non-data-aided algorithm to the individual candidate signal to estimate a sampling phase deviation without using knowledge of transmitted symbol values.

Path selector 412 can receive the plurality of candidate signals from selectable delay paths 470 and path selection signal 496 from signal quality assessment 410 and can select and output a selected candidate signal as phase-adjusted recovered symbols 304. Path selector 412 can operate as a multiplexer selecting among the plurality of candidate signals based on path selection signal 496. In some examples, path selector 412 can update the selected candidate signal on a per-clock or per-symbol-block basis, enabling blind timing recovery 302 to track changes in EEPN-induced timing jitter 182 as chromatic dispersion or laser phase noise characteristics of the optical link change over time, without being subject to the latency constraints of timing recovery feedback loop 280.

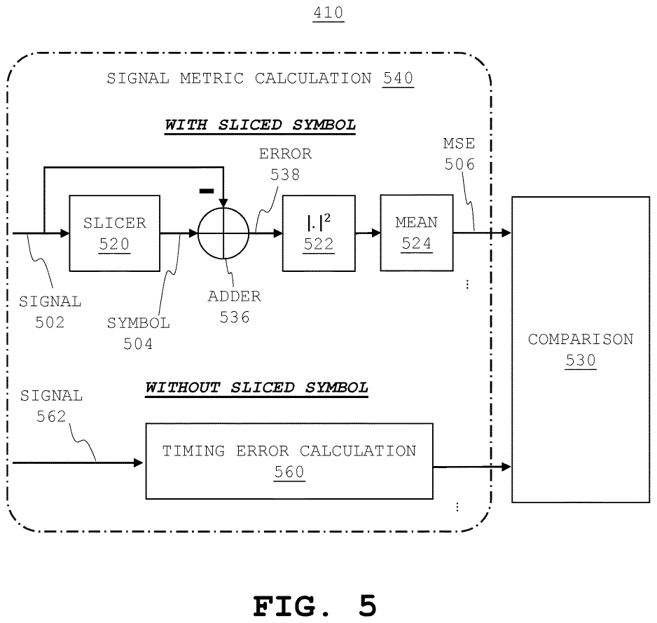

FIG. 5 illustrates an implementation of signal quality assessment 410, according to some examples of the disclosure. Signal quality assessment 410 comprises one or more of: signal metric calculation 540 and comparison 530. Signal metric calculation 540 can determine a signal metric for an individual candidate signal received from selectable delay paths 470 using one or more of a sliced-symbol-based computation or a non-sliced-symbol-based computation, as illustrated by the “with sliced symbol” and “without sliced symbol” paths in FIG. 5, respectively. Signal quality assessment 410 can determine a plurality of signal metrics, where an individual signal metric corresponds to an individual candidate signal of the plurality of candidate signals output by selectable delay paths 470 and can output the plurality of signal metrics to comparison 530.

For computing a signal metric based on a sliced symbol, signal metric calculation 540 can comprise one or more of: slicer 520, adder 536, magnitude-squared block 522, and mean 524. Slicer 520 can receive signal 502, which is an individual candidate signal output by an individual signal path of selectable delay paths 470, and can generate symbol 504 by slicing signal 502 to produce a hard-decision output representing a nearest constellation point to signal 502. Adder 536 can form error signal 538 by computing a difference between signal 502 and symbol 504, where error signal 538 represents a deviation of signal 502 from the nearest constellation point. Magnitude-squared block 522 can compute a magnitude-squared value of error signal 538. Mean 524 can compute a mean of the magnitude-squared values over a plurality of symbols to produce MSE 506 as the signal metric for signal 502. MSE 506 is indicative of the timing correctness of the individual candidate signal. A lower MSE 506 corresponds to a tighter signal constellation and a more correct timing offset. A higher MSE 506 corresponds to a more spread signal constellation and a less correct timing offset.

In some examples, signal metric calculation 540 can determine a signal metric for an individual candidate signal without using sliced symbols, using timing error calculation 560. Timing error calculation 560 can receive signal 562, which is an individual candidate signal output by an individual signal path of selectable delay paths 470, and can compute a timing error of signal 562 using a non-data-aided timing error detection algorithm that does not use knowledge of transmitted symbol values or sliced symbols. Examples of non-data-aided timing error detection algorithms applicable to timing error calculation 560 can include, but are not limited to, a Gardner timing error detector or other non-data-aided timing error detectors. Timing error calculation 560 can output a timing error as the signal metric for signal 562, where a lower timing error magnitude is indicative of a more correct timing offset for the individual candidate signal.

In some examples, signal metric calculation 540 can compute signal metrics for a plurality of candidate signals in parallel, where an individual instance of signal metric calculation 540 is associated with an individual signal path of selectable delay paths 470. In other examples, signal metric calculation 540 can compute signal metrics for the plurality of candidate signals sequentially, reusing one or more of slicer 520, adder 536, magnitude-squared block 522, mean 524, or timing error calculation 560 across the plurality of candidate signals.

In some examples, the number of symbols used by mean 524 to compute MSE 506, and the number of averaging iterations applied, can be tunable parameters of signal quality assessment 410 that control a tradeoff between the accuracy of the signal metric and the responsiveness of blind timing recovery 302 to changes in EEPN-induced timing jitter 182 as illustrated in FIG. 1.

Comparison 530 can receive a plurality of signal metrics output by signal metric calculation 540, where the plurality of signal metrics comprises an individual signal metric for each individual candidate signal of the plurality of candidate signals. Comparison 530 can identify a selected candidate signal having a minimum signal metric, in examples where the signal metric represents a timing error or MSE 506. Comparison 530 can identify a selected candidate signal having a maximum signal metric, in examples where the signal metric represents a signal quality measure. Comparison 530 can output path selection signal 496 identifying the selected candidate signal to path selector 412.

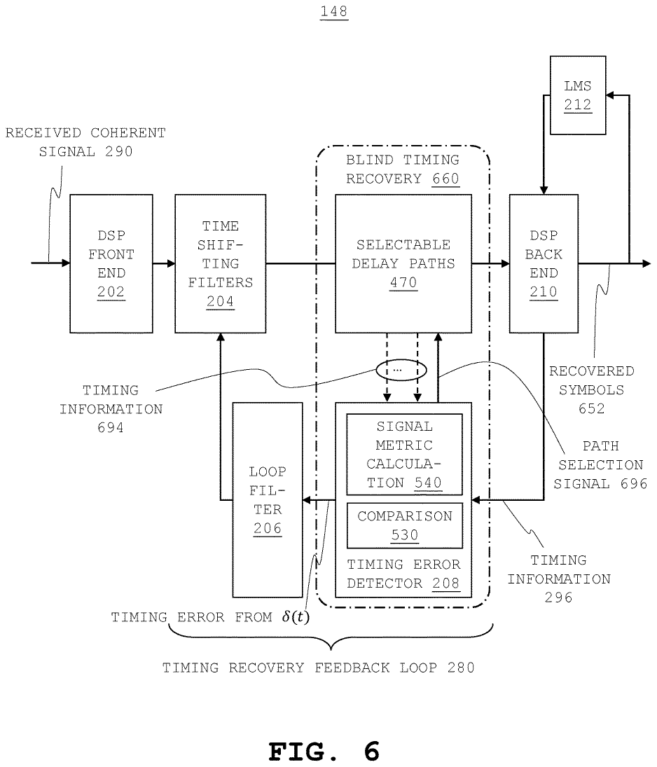

FIG. 6 illustrates an implementation of DSP 148 (e.g., in a transceiver) having blind timing recovery 660, according to some examples of the disclosure. In contrast to the implementation illustrated in FIG. 3, in which blind timing recovery 302 is disposed after DSP back end 210, blind timing recovery 660 in FIG. 6 is disposed between DSP front end 202 and DSP back end 210 and is integrated with timing error detector 208 inside timing recovery feedback loop 280. DSP 148 in FIG. 6 comprises one or more of DSP front end 202, time shifting filters 204, blind timing recovery 660, loop filter 206, DSP back end 210, and LMS equalizer 212.

Time shifting filters 204 can receive a processed digital signal output by DSP front end 202 and can apply a coarse timing adjustment to the processed digital signal based on timing information received from loop filter 206. Time shifting filters 204 can perform a coarse timing correction to bring the timing of the processed digital signal within an acceptable range prior to further processing by blind timing recovery 660 and DSP back end 210. Time shifting filters 204 can receive a filtered timing signal from loop filter 206 and output a coarse-timing-corrected digital signal to blind timing recovery 660.

Blind timing recovery 660 is disposed after time shifting filters 204 and before DSP back end 210 and is integrated with timing error detector 208 inside timing recovery feedback loop 280. Blind timing recovery 660 comprises one or more of: selectable delay paths 470, signal metric calculation 540, and comparison 530. Selectable delay paths 470 can receive the coarse-timing-corrected digital signal output by time shifting filters 204 and can apply a plurality of timing offsets to produce a plurality of candidate signals, as described in connection with FIG. 4. Signal metric calculation 540 and comparison 530 together implement timing error detector 208 in this example illustrated in FIG. 6, such that the signal metric computation and path selection functions of blind timing recovery 660 are performed within timing error detector 208 inside timing recovery feedback loop 280.

In some examples, timing error detector 208 includes signal metric calculation 540 and comparison 530, where signal metric calculation 540 and comparison 530 serve a dual purpose. Signal metric calculation 540 can determine a plurality of signal metrics for the plurality of candidate signals output by selectable delay paths 470, and comparison 530 can output path selection signal 696 to DSP back end 210 to select a selected candidate signal for further processing as recovered symbols 652. Concurrently, timing error detector 208 can derive a timing error from the reference path δ(t) of selectable delay paths 470, labeled as timing error from δ(t) in FIG. 6, and output the timing error to loop filter 206 as an input to timing recovery feedback loop 280. In this manner, timing error detector 208 leverages the reference candidate signal corresponding to δ(t) to provide a timing error estimate to loop filter 206 for coarse timing correction by time shifting filters 204, while simultaneously or concurrently performing blind timing recovery across the plurality of candidate signals to address EEPN-induced timing jitter that may not be accounted for by time shifting filters 204.

Timing information 694 can be received by timing error detector 208 from selectable delay paths 470 and can comprise the plurality of candidate signals produced by selectable delay paths 470. Timing information 694 can be used by signal metric calculation 540 to compute a signal metric for an individual candidate signal of the plurality of candidate signals. In examples where signal metric calculation 540 computes an MSE-based signal metric, signal metric calculation 540 can slice an individual candidate signal of timing information 694 to generate a sliced symbol representing a nearest constellation point, form an error signal as a difference between the individual candidate signal and the sliced symbol, and determine a mean-squared value of the error signal as the signal metric for the individual candidate signal, as described in connection with FIG. 5. In some examples, signal metric calculation 540 can alternatively compute a signal metric for an individual candidate signal of timing information 694 using a non-data-aided timing error detection algorithm that does not require sliced symbols, such as a Gardner timing error detector or another non-data-aided timing error detector, as further described in connection with FIG. 5.

Path selection signal 696 can be output by comparison 530 to selectable delay paths 470 to identify a selected candidate signal among the plurality of candidate signals output by selectable delay paths 470. Selectable delay paths 470 can comprise a path selector, such as path selector 412 described in connection with FIG. 4, that receives path selection signal 696 and outputs a selected candidate signal to DSP back end 210 for further back end processing. DSP back end 210 can perform one or more back end processing operations on the selected candidate signal to produce recovered symbols 652, as described in connection with FIG. 2. In this example, recovered symbols 652 represent the output of DSP back end 210 after processing the selected candidate signal identified by blind timing recovery 660, and correspond to phase-adjusted recovered symbols with an optimal timing correction applied to compensate for EEPN-induced timing jitter 182 as illustrated in FIG. 1.

An advantage of the example illustrated in FIG. 6 is that blind timing recovery 660 is positioned between DSP front end 202 and DSP back end 210, such that the selected candidate signal with an optimal timing correction is provided as an input to DSP back end 210 rather than being applied after DSP back end 210 as in FIG. 3. This placement can allow DSP back end 210, including one or more of FCR, BPS, post-filtering, and BER estimation stages, to operate on a timing-corrected digital signal, potentially improving the performance of each back end processing stage by reducing the residual timing jitter present in the input signal. Furthermore, by integrating blind timing recovery 660 with timing error detector 208 inside timing recovery feedback loop 280, the implementation of FIG. 6 can reuse signal metric calculation 540 and comparison 530 for both the blind timing recovery path selection function and the timing error estimation function of timing recovery feedback loop 280 and reduce implementation complexity.

### Example Implementations of Selectable Delay Paths Provided in Blind Timing Recovery

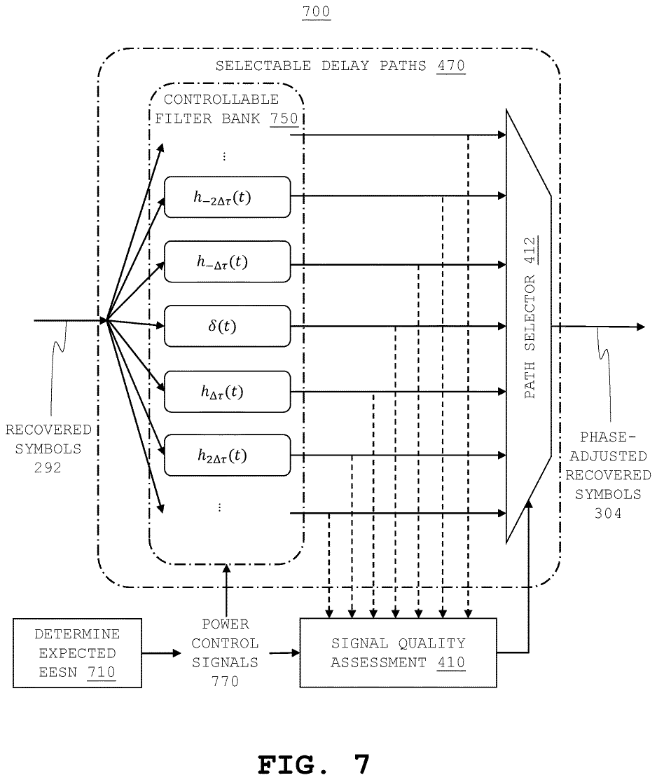

FIG. 7 illustrates an implementation of blind timing recovery 700 with selectable delay paths 470, according to some examples of the disclosure. Blind timing recovery 700 includes selectable delay paths 470, signal quality assessment 410, and determine expected EEPN 710. In this illustration, blind timing recovery 700 receives recovered symbols 292 and outputs phase-adjusted recovered symbols 304. Selectable delay paths 470 include controllable filter bank 750 and path selector 412.

Determine expected EEPN 710 can generate one or more power control signals 770 to selectively enable or disable individual signal paths of controllable filter bank 750 based on an expected severity or level of EEPN-induced timing jitter 182 illustrated in FIG. 1.

Controllable filter bank 750 can comprise a plurality of signal paths, each signal path applying an individual timing offset to recovered symbols 292 to produce an individual candidate signal, as described in connection with filter bank 450 of FIG. 4. In the example illustrated in FIG. 7, controllable filter bank 750 comprises timing shift filters, e.g., h_{-2Δτ}(t), h_{-Δτ}(t), δ(t), h_{Δτ}(t), and h_{2Δτ}(t), as well as possible additional signal paths indicated by ellipses above and below. Controllable filter bank 750 can selectively enable or disable an individual signal path based on power control signals 770, such that only a subset of the plurality of signal paths are active at any given time. Disabling individual signal paths of controllable filter bank 750 can reduce the power consumption of selectable delay paths 470 and signal quality assessment 410 by reducing the number of candidate signals that need to be generated and evaluated.

In some examples, power control signals 770 can gate a portion of signal quality assessment 410 corresponding to disabled signal paths of controllable filter bank 750. For example, when determine expected EEPN 710 generates power control signals 770 to disable one or more signal paths of controllable filter bank 750, such as h_{-2Δτ}(t) and h_{2Δτ}(t), power control signals 770 can simultaneously or concurrently gate one or more corresponding signal metric computations in signal metric calculation 540 and one or more corresponding inputs to comparison 530 illustrated in FIG. 5, such that signal quality assessment 410 does not perform unnecessary signal metric computations for candidate signals that are not generated by controllable filter bank 750. Gating a portion of signal quality assessment 410 in this manner can further reduce the power consumption of blind timing recovery beyond the savings achieved by disabling signal paths of controllable filter bank 750 alone, since both the signal generation and signal metric computation stages of blind timing recovery consume power proportional to the number of active signal paths. In another example, power control signals 770 can disable signal metric computation in signal metric calculation 540 for one or more candidate signals while the corresponding signal paths of controllable filter bank 750 remain active and continue to generate candidate signals. In such examples, signal quality assessment 410 can compute signal metrics for only a subset of the plurality of candidate signals output by controllable filter bank 750, such as candidate signals corresponding to timing offsets closest to a previously selected optimal timing offset, while bypassing signal metric computation for candidate signals corresponding to timing offsets that are unlikely to represent an optimal timing correction based on a prior determination by determine expected EEPN 710. Gating a portion of signal quality assessment 410 in this manner can reduce the power consumed by signal metric calculation 540 and comparison 530 illustrated in FIG. 5 without reducing the number of candidate signals available to path selector 412, preserving the full timing offset range of controllable filter bank 750 while achieving power savings in the signal metric computation stage of blind timing recovery.

Determine expected EEPN 710 can estimate an expected severity of EEPN-induced timing jitter 182 as illustrated in FIG. 1 for the communication system and can generate power control signals 770 based on the estimated expected EEPN. Determine expected EEPN 710 can estimate the expected EEPN based on one or more of: an estimated chromatic dispersion of the optical link, a link length, or other operating parameters of the communication system. For example, determine expected EEPN 710 can receive an estimated chromatic dispersion value from an electrical chromatic dispersion compensation block of DSP front end 202 (e.g., where chromatic dispersion is linearly proportional to link length) and can use the estimated chromatic dispersion to determine the expected range of EEPN-induced timing jitter 182 as illustrated in FIG. 1 and thereby determine how many signal paths of controllable filter bank 750 need to be active to cover the expected timing offset range.

Power control signals 770 can be output by determine expected EEPN 710 to controllable filter bank 750 to selectively enable or disable individual signal paths based on the expected severity of EEPN-induced timing jitter 182 as illustrated in FIG. 1. In examples where the estimated chromatic dispersion or link length is low, such as a short optical link of approximately 100 kilometers, determine expected EEPN 710 can generate power control signals 770 to disable signal paths corresponding to larger timing offsets, such as h_{-2Δτ}(t) and h_{2Δτ}(t), retaining only signal paths corresponding to smaller timing offsets centered around δ(t), since EEPN-induced timing jitter 182 as illustrated in FIG. 1 is less severe at low chromatic dispersion and a narrower timing offset range is sufficient to identify an optimal timing correction. In examples where the estimated chromatic dispersion or link length is high, such as a long optical link of approximately 1000 kilometers or more, determine expected EEPN 710 can generate power control signals 770 to enable a greater number of signal paths spanning a wider range of timing offsets to ensure that an optimal timing offset can be identified across the broader range of EEPN-induced timing jitter 182 as illustrated in FIG. 1 expected at high chromatic dispersion.

In some examples, power control signals 770 can be based on a power mode of the communication system. For example, in a low-power mode, determine expected EEPN 710 can generate power control signals 770 to disable a greater number of signal paths of controllable filter bank 750, regardless of the estimated chromatic dispersion, reducing the power consumption of blind timing recovery at the cost of a reduced timing offset range. In a normal or high-performance mode, determine expected EEPN 710 can generate power control signals 770 to enable a greater number of signal paths to maximize the timing correction capability of blind timing recovery.

In some examples, power control signals 770 generated by determine expected EEPN 710 can be based on a combination of power mode and link length, such that determine expected EEPN 710 applies a link-length-based determination of a number of active signal paths as a starting point and further reduces the number of active signal paths based on a power mode constraint, enabling a tunable tradeoff between power consumption and timing correction capability of controllable filter bank 750.

In some examples, controllable filter bank 750 can be controlled by one or more registers storing values that determine which individual signal paths of controllable filter bank 750 are enabled or disabled. The one or more registers can be programmed by firmware or software executing on a processor of the communication system, such as processor 146, to set power control signals 770 based on one or more of: an estimated chromatic dispersion of the optical link, a link length, a power mode of the communication system, or a timing offset derived from a prior operation of blind timing recovery. For example, a register value can specify a number of active signal paths of controllable filter bank 750, a range of timing offsets to be covered by the active signal paths, or an individual timing step &r to be applied between adjacent active signal paths. In some examples, the one or more registers can be updated over time during operation of the communication system, for example in response to a change in link configuration or a change in power mode, enabling controllable filter bank 750 to adapt its active signal paths to changing operating conditions, uses, or applications. In some examples, the one or more registers can additionally store values that control gating of a portion of signal quality assessment 410, such that a single register write can simultaneously update the active signal paths of controllable filter bank 750 and the corresponding signal metric computations performed by signal quality assessment 410.

Path selector 412 can receive the plurality of candidate signals from the enabled signal paths of controllable filter bank 750 and path selection signal 496 from signal quality assessment 410 and can output a selected candidate signal as phase-adjusted recovered symbols 304, as described in connection with FIG. 4.

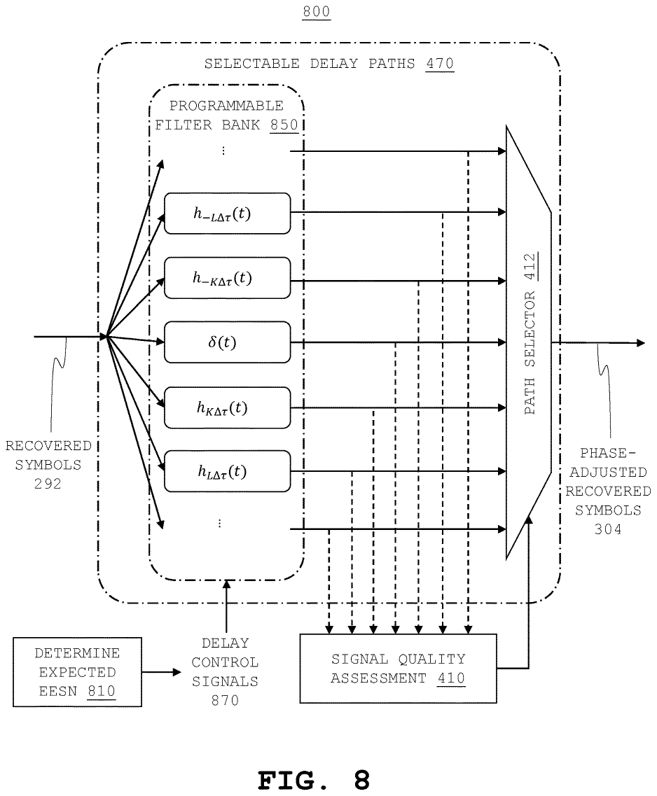

FIG. 8 illustrates an implementation of blind timing recovery 800 with selectable delay paths 470, according to some examples of the disclosure. Blind timing recovery 800 includes selectable delay paths 470, signal quality assessment 410, and determine expected EEPN 810. In this illustration, blind timing recovery 800 receives recovered symbols 292 and outputs phase-adjusted recovered symbols 304. Selectable delay paths 470 include programmable filter bank 850 and path selector 412.

Programmable filter bank 850 can comprise a plurality of signal paths, each signal path applying an individual timing offset to recovered symbols 292 to produce an individual candidate signal. In the example of FIG. 8, programmable filter bank 850 comprises timing shift filters, e.g., h_{-LΔτ}(t), h_{-KΔτ}(t), δ(t), h_{KΔτ}(t), and h_{LΔτ}(t), as well as possible additional signal paths indicated by ellipses above and below, wherein K and L represent programmable scaling factors that determine the timing offset of each individual signal path. Rather than using timing offsets that are fixed integer multiples of a uniform timing step Δτ, programmable filter bank 850 can apply timing offsets that are individually programmable via delay control signals 870, such that both the spacing between adjacent timing offsets and the overall range of timing offsets spanned by programmable filter bank 850 can be configured based on operating conditions of the communication system. Timing shift filter δ(t) represents an individual signal path applying a zero timing offset.

Determine expected EEPN 810 can estimate an expected severity or level of EEPN-induced timing jitter 182 as illustrated in FIG. 1 for the communication system and can generate delay control signals 870 based on the estimated expected EEPN. Determine expected EEPN 810 can estimate the expected EEPN based on one or more of an estimated chromatic dispersion of the optical link, a link length, a power mode of the communication system, or other operating parameters of the communication system. Determine expected EEPN 810 generates delay control signals 870 to program the timing offsets applied by individual signal paths of programmable filter bank 850, enabling a finer-grained adaptation of the timing offset range and resolution of programmable filter bank 850 to the expected severity or level of EEPN-induced timing jitter 182 as illustrated in FIG. 1.

Delay control signals 870 can be output by determine expected EEPN 810 to programmable filter bank 850 to set one or more of a timing step Δτ applied between adjacent signal paths, a scaling factor K or L determining the timing offset of individual signal paths, and a total number of active signal paths in programmable filter bank 850. For example, for a short optical link with low chromatic dispersion, determine expected EEPN 810 can generate delay control signals 870 to set a small timing step Δτ and small scaling factors K and L, configuring programmable filter bank 850 to cover a narrow range of timing offsets with fine resolution suited to the low EEPN-induced timing jitter 182 as illustrated in FIG. 1, expected at low chromatic dispersion. For a long optical link with high chromatic dispersion, determine expected EEPN 810 can generate delay control signals 870 to set a larger timing step Δτ and larger scaling factors K and L, configuring programmable filter bank 850 to cover a wider range of timing offsets to ensure that an optimal timing correction can be identified across the broader range of EEPN-induced timing jitter 182 as illustrated in FIG. 1, expected at high chromatic dispersion. In some examples, delay control signals 870 can be stored in one or more registers programmed by firmware or software executing on a processor of the communication system, such as processor 146 illustrated in FIG. 1, enabling programmable filter bank 850 to be reconfigured in response to changes in link configuration or operating conditions.

Signal quality assessment 410 can receive the plurality of candidate signals output by programmable filter bank 850 and can determine a plurality of signal metrics for the plurality of candidate signals, as described in connection with FIG. 5. Signal quality assessment 410 can output path selection signal 496 to path selector 412 based on the plurality of signal metrics, wherein path selection signal 496 identifies a selected candidate signal among the plurality of candidate signals having a signal metric indicative of a highest signal quality or a lowest timing error.

Path selector 412 can receive the plurality of candidate signals from programmable filter bank 850 and path selection signal 496 from signal quality assessment 410, and can output a selected candidate signal as phase-adjusted recovered symbols 304, as described in connection with FIG. 4.

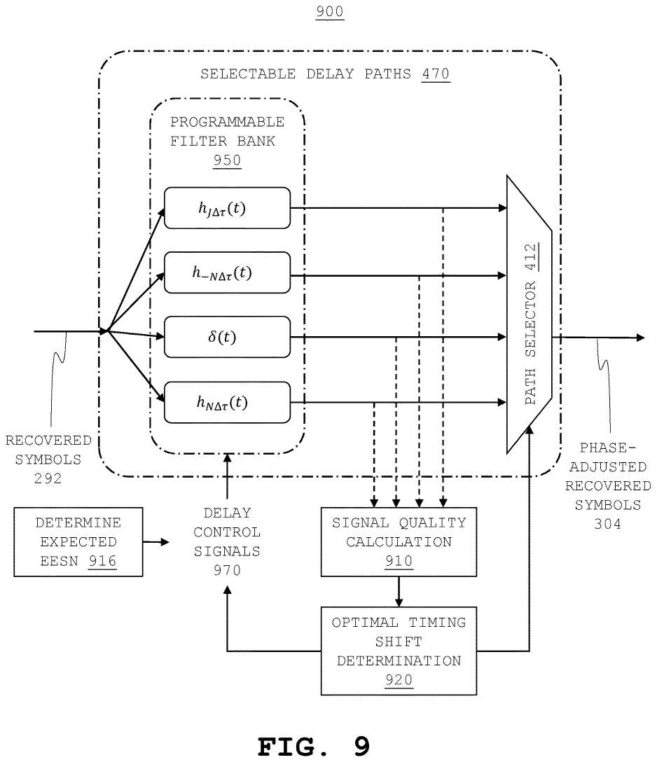

FIG. 9 illustrates an implementation of blind timing recovery 900 with selectable delay paths 470 and curve-fitting, according to some examples of the disclosure. Blind timing recovery 900 includes one or more of selectable delay paths 470, signal quality calculation 910, optimal timing shift determination 920, and determine expected EEPN 916. In this illustration, blind timing recovery 900 receives recovered symbols 292 and outputs phase-adjusted recovered symbols 304. Selectable delay paths 470 include programmable filter bank 950 and path selector 412.

In the example illustrated in FIG. 9, blind timing recovery 900 employs a (reduced) number of timing shift filters in programmable filter bank 950 in combination with optimal timing shift determination 920 to estimate an optimal timing correction using curve-fitting, reducing implementation complexity and power consumption compared to the implementations (e.g., illustrated in FIGS. 4, 7, and 8) while maintaining timing correction performance.

Programmable filter bank 950 can comprise a plurality of signal paths, each signal path applying an individual timing offset to recovered symbols 292 to produce an individual candidate signal. In the example illustrated in FIG. 9, programmable filter bank 950 comprises one or more timing shift filters, e.g., h_{JΔτ}(t), h_{-NΔτ}(t), δ(t), and h_{NΔτ}(t), where J and N represent programmable scaling factors determining the timing offsets of individual signal paths. Programmable filter bank 950 can employ a sparse set of timing shift filters spanning a range of timing offsets, wherein the spacing between individual timing offsets need not be uniform and can be configured by delay control signals 970 to cover a range of timing offsets suited to the expected severity or level of EEPN-induced timing jitter 182, as illustrated in FIG. 1. The use of a reduced number of timing shift filters in programmable filter bank 950 (e.g., compared to filter bank 450 of FIG. 4) can reduce the implementation complexity and power consumption of selectable delay paths 470, with optimal timing shift determination 920 compensating for the reduced timing offset resolution of programmable filter bank 950 by deriving an estimated optimal timing offset from curve-fitting applied to the plurality of signal metrics.

Signal quality calculation 910 can receive the plurality of candidate signals output by programmable filter bank 950 and can determine a plurality of signal metrics for the plurality of candidate signals, as described in connection with FIG. 5. An individual signal metric can be determined for an individual candidate signal using one or more of: an MSE-based computation or a non-data-aided timing error computation, as described in connection with signal metric calculation 540 of FIG. 5. Signal quality calculation 910 can output the plurality of signal metrics to optimal timing shift determination 920.

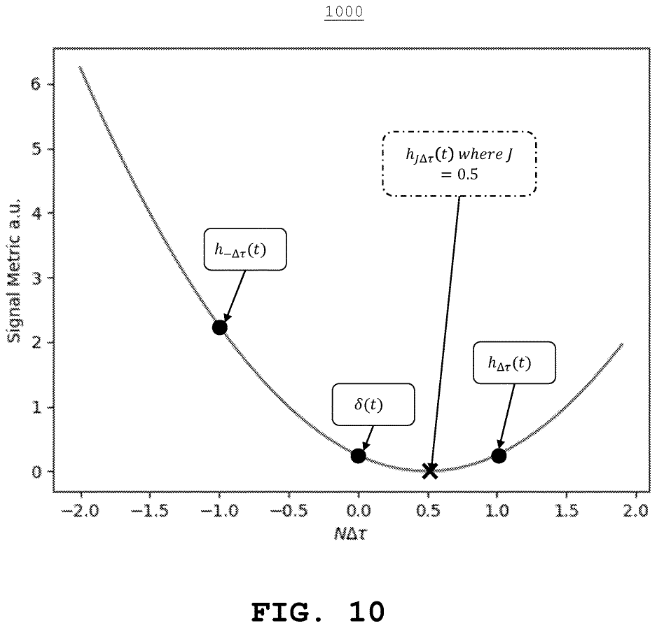

Optimal timing shift determination 920 can receive the plurality of signal metrics from signal quality calculation 910 and can apply curve-fitting to derive an estimated optimal timing offset for recovered symbols 292. Optimal timing shift determination 920 can fit a curve, such as a parabolic or polynomial curve, to the plurality of signal metrics as a function of the respective timing offsets of the plurality of candidate signals output by programmable filter bank 950 and can derive an estimated optimal timing offset corresponding to a minimum or maximum of the fitted curve. An example curve-fitting technique is illustrated in FIG. 10. The estimated optimal timing offset derived by optimal timing shift determination 920 can correspond to a timing offset that is not directly represented by the individual signal paths of programmable filter bank 950, enabling blind timing recovery 900 to achieve a timing correction resolution finer than the spacing between individual timing offsets of programmable filter bank 950 without using a larger number of timing shift filters.

Optimal timing shift determination 920 can output a path selection signal to path selector 412.

In some examples, optimal timing shift determination 920 can output the estimated optimal timing offset directly to programmable filter bank 950 via delay control signals 970 to set scaling factor J to the estimated optimal timing offset. In such examples, delay control signals 970 can program scaling factor J of timing shift filter h_{JΔτ}(t) to correspond to the estimated optimal timing offset derived by optimal timing shift determination 920 from curve-fitting applied to the plurality of signal metrics. Optimal timing shift determination 920 can output a path selection such that the signal path with timing shift filter h_{JΔτ}(t) is selected by path selector 412. Path selector 412 can select the candidate signal corresponding to the programmed scaling factor J as phase-adjusted recovered symbols 304, enabling blind timing recovery 900 to output a timing-corrected signal at the estimated optimal timing offset.

In some examples, optimal timing shift determination 920 can output the estimated optimal timing offset directly to programmable filter bank 950 via delay control signals 970 to configure programmable filter bank 950 to generate an individual candidate signal corresponding to the estimated optimal timing offset as one of the plurality of candidate signals in a subsequent evaluation. In this manner, optimal timing shift determination 920 can iteratively refine the timing correction or offset applied by blind timing recovery 900 by progressively updating scaling factor J and/or N via delay control signals 970 to converge on an optimal timing offset for recovered symbols 292.

In some examples, optimal timing shift determination 920 can output the estimated optimal timing offset directly to programmable filter bank 950 via delay control signals 970 to center the timing offset range of programmable filter bank 950 around the estimated optimal timing offset derived by optimal timing shift determination 920, and optionally reduce the timing step &x between adjacent signal paths of programmable filter bank 950 to increase timing offset resolution in the vicinity of the estimated optimal timing offset.

In some examples, determine expected EEPN 916 can generate modified delay control signals 970 to reprogram programmable filter bank 950 for a subsequent evaluation. In some examples, determine expected EEPN 916 can receive one or more of: an estimated chromatic dispersion of the optical link, a link length, or a power mode of the communication system, as inputs for generating or modifying delay control signals 970, such that the timing offset range and resolution of programmable filter bank 950 are jointly determined by the estimated optimal timing offset from optimal timing shift determination 920 and the operating conditions of the communication system. Delay control signals 970 can be stored in one or more registers programmed by firmware or software executing on a processor of the communication system, such as processor 146 illustrated in FIG. 1, enabling programmable filter bank 950 to be reconfigured in response to updated estimates from optimal timing shift determination 920 or changes in operating conditions.

Selectable delay paths 470 illustrated in FIGS. 4, 7-9 are shown to receive recovered symbols 292 and output phase-adjusted recovered symbols 304, where selectable delay paths 470 may be placed at the output of a DSP back end. It is envisioned by the disclosure that selectable delay paths 470 can be placed at other locations in the DSP processing chain of DSP 148 as illustrated in FIGS. 3 and 6. For example, selectable delay paths 470 can be placed between DSP front end 202 and DSP back end 210, as illustrated in FIG. 6, wherein selectable delay paths 470 receive a processed digital signal output by time shifting filters 204 as the digital signal and output a selected candidate signal to DSP back end 210 for further back end processing. In another example, selectable delay paths 470 can be placed after LMS equalizer 212 as illustrated in FIGS. 3 and 6, wherein selectable delay paths 470 receive an equalized digital signal output by LMS equalizer 212 as the digital signal and output a selected candidate signal to DSP back end 210 for further processing. In each of these examples, the operations described in connection with FIGS. 4, 7-9 are applicable at various possible placements of selectable delay paths 470 in the DSP processing chain where the digital signal received by selectable delay paths 470 is derived from received coherent signal 290 received over an optical link.

In some examples, a determine expected EEPN block, such as those described in connection with FIGS. 7-9, can be implemented as a hardware logic block, a firmware module executing on a processor of the communication system such as processor 146, or a combination thereof. A determine expected EEPN block can receive one or more operating parameters of the communication system, including one or more of an estimated chromatic dispersion value derived from an electrical chromatic dispersion compensation (ECD) stage of DSP front end 202, a configured link length stored in a register accessible by firmware, or a power mode setting of the communication system, and can compute an estimated expected range of EEPN-induced timing jitter based on these parameters. In some examples, a determine expected EEPN block can implement a lookup table mapping one or more of chromatic dispersion and link length to a recommended number of active signal paths and timing offset range for the associated filter bank. In some examples, a determine expected EEPN block can implement an analytical computation based on the relationship between EEPN-induced timing jitter magnitude and chromatic dispersion to derive the expected timing offset range and thereby determine appropriate control signals for the associated filter bank.

FIG. 10 illustrates curve-fitting utilizing three delay paths, according to some examples of the disclosure. Specifically, FIG. 10 illustrates curve-fitting applied to a plurality of signal metrics to determine an optimal timing offset. The horizontal axis represents timing offset NΔτ, wherein N is a scaling factor and Δτ is a timing step, and the vertical axis represents a signal metric in arbitrary units (a.u.), wherein a lower signal metric value is indicative of a higher signal quality and a more correct timing offset. Three discrete signal metric values are shown, corresponding to candidate signals generated by timing shift filters h_{-Δτ}(t), δ(t), and h_{Δτ}(t) of programmable filter bank 950 illustrated in FIG. 9 at timing offsets NΔτ=−1, 0, and +1, respectively. The three discrete signal metric values represent a sparse set of measurements obtained from a reduced number of timing shift filters in programmable filter bank 950, illustrating that optimal timing shift determination 920 can derive an estimated optimal timing offset from as few as three candidate signals without using a large number of finely spaced timing shift filters.

Optimal timing shift determination 920 illustrated in FIG. 9 can apply curve-fitting to the three discrete signal metric values to fit a curve, such as the parabolic curve illustrated in FIG. 10, to the plurality of signal metrics as a function of respective timing offsets NΔτ of the plurality of candidate signals. The minimum of the fitted curve, indicated by an x symbol in FIG. 10, corresponds to an estimated optimal timing offset of NΔτ=0.5, labeled h_{JΔτ}(t) where J=0.5 in FIG. 10. The estimated optimal timing offset J=0.5 does not correspond exactly to any of the discrete timing offsets NΔτ=−1, 0, or +1 of the three timing shift filters of programmable filter bank 950 illustrated in FIG. 9, illustrating that curve-fitting enables optimal timing shift determination 920 to derive an estimated optimal timing offset with a finer resolution than the spacing between individual timing shift filters of programmable filter bank 950, without using additional timing shift filters at intermediate timing offsets.

Optimal timing shift determination 920 illustrated in FIG. 9 can use the estimated optimal timing offset J=0.5 to generate updated delay control signals 970 illustrated in FIG. 9 to set scaling factor J of timing shift filter h_{JΔτ}(t) in programmable filter bank 950 to the estimated optimal timing offset, as described in connection with FIG. 9. In some examples, path selector 412 can select a candidate signal from programmable filter bank 950 corresponding to the timing offset closest to the estimated optimal timing offset J=0.5 as phase-adjusted recovered symbols 304. In this manner, FIG. 10 illustrates that blind timing recovery 900 can achieve a precise timing correction at a sub-filter-spacing resolution using a sparse set of timing shift filters in combination with curve-fitting applied by optimal timing shift determination 920, reducing the implementation complexity and power consumption of programmable filter bank 950 compared to a dense filter bank implementation.

### Example Methods for Blind Timing Recovery

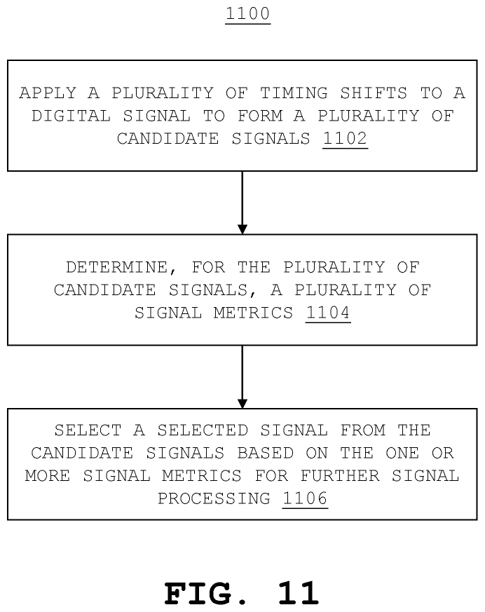

FIG. 11 depicts a flow chart illustrating method 1100 for blind timing recovery for laser phase noise induced equalization-enhanced phase noise, according to some examples of the disclosure. Method 1100 may be encoded in instructions and executed by a processor to carry out the operations of method 1100. Method 1100 may be implemented by one or more components illustrated in FIGS. 3-9.

In 1102, a plurality of timing shifts can be applied to a digital signal to form a plurality of candidate signals. The digital signal is derived from a coherent signal received over an optical path. The plurality of candidate signals comprise the digital signal and one or more time-shifted signals.

In 1104, for the plurality of candidate signals, a plurality of signal metrics can be determined.

In 1106, a selected signal can be selected from the plurality of candidate signals based on the one or more signal metrics for further signal processing.

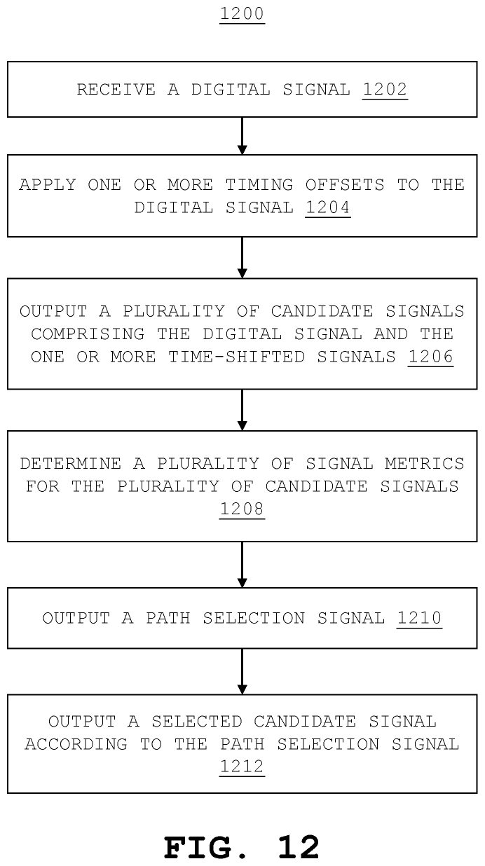

FIG. 12 depicts a flow chart illustrating method 1200 for blind timing recovery for laser phase noise induced equalization-enhanced phase noise, according to some examples of the disclosure. Method 1200 may be encoded in instructions and executed by a processor to carry out the operations of method 1200. Method 1200 may be implemented by one or more components illustrated in FIGS. 3-9.

In 1202, a plurality of signal paths may receive a digital signal.

In 1204, the plurality of signal paths may apply one or more timing offsets to the digital signal.

In 1206, the plurality of signal paths may output a plurality of candidate signals comprising the digital signal and one or more time-shifted signals. The digital signal is derived from a coherent signal received over an optical link.

In 1208, a signal assessment logic may determine a plurality of signal metrics for the plurality of candidate signals.

In 1210, the signal assessment logic may output a path selection signal.

In 1212, a path selector may output a selected candidate signal according to the path selection signal.

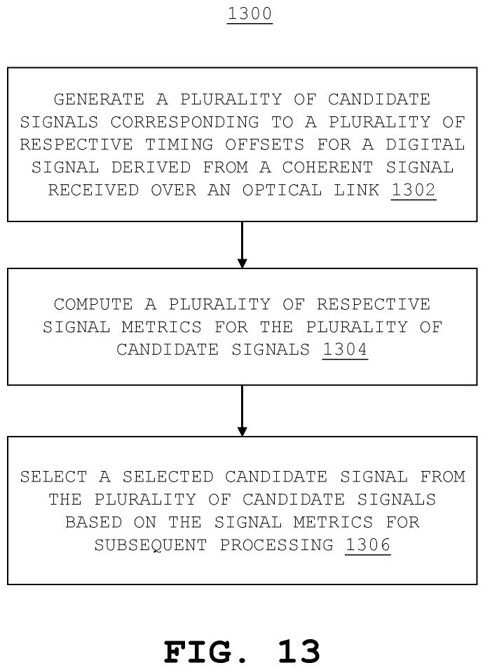

FIG. 13 depicts a flow chart illustrating method 1300 for blind timing recovery for laser phase noise induced equalization-enhanced phase noise, according to some examples of the disclosure. Method 1300 may be encoded in instructions and executed by a processor to carry out the operations of method 1300. Method 1300 may be implemented by one or more components illustrated in FIGS. 3-9.

In 1302, a plurality of candidate signals corresponding to a plurality of respective timing offsets can be generated for a digital signal derived from a coherent signal received over an optical link.

In 1304, a plurality of respective signal metrics can be computed for the plurality of candidate signals.

In 1306, a selected candidate signal can be selected from the plurality of candidate signals based on the plurality of signal metrics for subsequent processing.

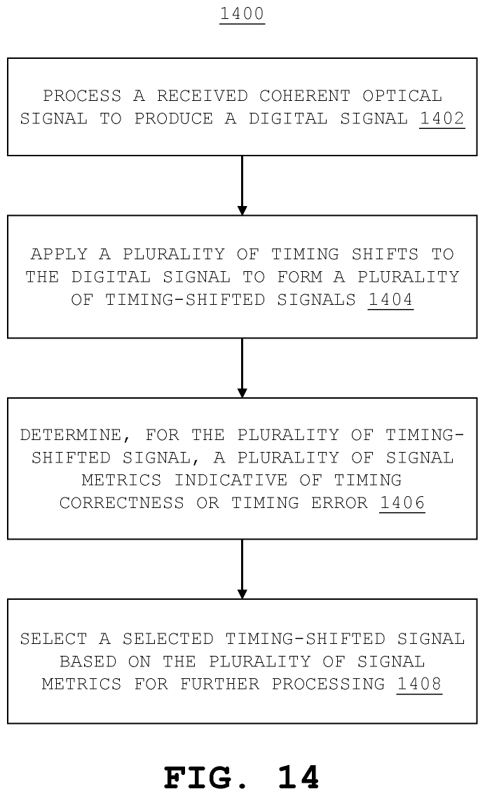

FIG. 14 depicts a flow chart illustrating a method for blind timing recovery for laser phase noise induced equalization-enhanced phase noise, according to some examples of the disclosure. Method 1400 may be encoded in instructions and executed by a processor to carry out the operations of method 1400. Method 1400 may be implemented by one or more components illustrated in FIGS. 3-9.

In 1402, a received coherent optical signal can be processed to produce a digital signal.

In 1404, a plurality of timing shifts can be applied to the digital signal to form a plurality of timing-shifted signals.

In 1406, a plurality of signal metrics indicative of timing correctness or timing error can be determined for the plurality of timing-shifted signals.

In 1408, a selected timing-shifted signal can be selected based on the plurality of signal metrics for further processing.

### SELECT EXAMPLES

Example 1 provides a digital signal processor of a communication system, the digital signal processor to execute instructions implementing blind timing recovery of equalization-enhanced phase noise that causes the digital signal processor to perform operations including applying a plurality of timing shifts to a digital signal to form a plurality of candidate signals, where the digital signal is derived from a coherent signal received over an optical path, and the plurality of candidate signals include the digital signal and one or more time-shifted signals; determining, for the plurality of candidate signals, a plurality of signal metrics; and selecting a selected signal from the plurality of candidate signals based on the plurality of signal metrics for further signal processing.

Example 2 provides the digital signal processor of example 1, where applying the plurality of timing shifts includes multiplying the digital signal by one or more phase masks corresponding to the plurality of timing shifts.

Example 3 provides the digital signal processor of example 1 or 2, where applying the plurality of timing shifts includes applying one or more finite impulse response filters corresponding to the plurality of timing shifts.

Example 4 provides the digital signal processor of any one of examples 1-3, where determining the plurality of signal metrics includes slicing a candidate signal of the plurality of candidate signals to generate a symbol; forming an error signal based on the candidate signal and the symbol; and determining a mean-squared value of the error signal.

Example 5 provides the digital signal processor of any one of examples 1-4, where determining the plurality of signal metrics includes determining a timing error of a candidate signal of the plurality of candidate signals.

Example 6 provides the digital signal processor of any one of examples 1-5, where selecting the selected signal includes determining the selected signal having a minimum signal metric or a maximum signal metric.

Example 7 provides the digital signal processor of any one of examples 1-6, where selecting the selected signal includes estimating a timing offset based on a curve fitted to the plurality of signal metrics.

Example 8 provides the digital signal processor of example 7, where selecting the selected signal includes selecting a candidate signal corresponding to the timing offset as the selected signal.

Example 9 provides the digital signal processor of example 7, where selecting the selected signal includes applying the timing offset to the digital signal using a programmable delay filter to generate the selected signal.

Example 10 provides one or more non-transitory computer-readable media storing instructions implementing blind timing recovery of equalization-enhanced phase noise, that when executed by a digital signal processor, cause the digital signal processor to perform operations including applying a plurality of timing shifts to a digital signal to form a plurality of candidate signals, where the digital signal is derived from a coherent signal received over an optical path, and the plurality of candidate signals include the digital signal and one or more time-shifted signals; determining, for the plurality of candidate signals, a plurality of signal metrics; and selecting a selected signal from the plurality of candidate signals based on the plurality of signal metrics for further signal processing.

Example 11 provides the one or more non-transitory computer-readable media of example 10, where applying the plurality of timing shifts includes multiplying the digital signal by one or more phase masks corresponding to the plurality of timing shifts.

Example 12 provides the one or more non-transitory computer-readable media of example 10 or 11, where applying the plurality of timing shifts includes applying one or more finite impulse response filters corresponding to the plurality of timing shifts.

Example 13 provides the one or more non-transitory computer-readable media of any one of examples 10-12, where determining the plurality of signal metrics includes slicing a candidate signal of the plurality of candidate signals to generate a symbol; forming an error signal based on the candidate signal and the symbol; and determining a mean-squared value of the error signal.

Example 14 provides the one or more non-transitory computer-readable media of any one of examples 10-13, where determining the plurality of signal metrics includes determining a timing error of a candidate signal of the plurality of candidate signals.

Example 15 provides the one or more non-transitory computer-readable media of any one of examples 10-14, where selecting the selected signal includes determining the selected signal having a minimum signal metric or a maximum signal metric.

Example 16 provides the one or more non-transitory computer-readable media of any one of examples 10-15, where selecting the selected signal includes estimating a timing offset based on a curve fitted to the plurality of signal metrics.

Example 17 provides the one or more non-transitory computer-readable media of example 16, where selecting the selected signal includes selecting a candidate signal corresponding to the timing offset as the selected signal.

Example 18 provides the one or more non-transitory computer-readable media of example 16, where selecting the selected signal includes applying the timing offset to the digital signal using a programmable delay filter to generate the selected signal.

Example 19 provides a method for blind timing recovery of equalization-enhanced phase noise, the method including applying a plurality of timing shifts to a digital signal to form a plurality of candidate signals, where the digital signal is derived from a coherent signal received over an optical path, and the plurality of candidate signals include the digital signal and one or more time-shifted signals; determining, for the plurality of candidate signals, a plurality of signal metrics; and selecting a selected signal from the plurality of candidate signals based on the plurality of signal metrics for further signal processing.

Example 20 provides the method of example 19, where applying the plurality of timing shifts includes multiplying the digital signal by one or more phase masks corresponding to the plurality of timing shifts.

Example 21 provides the method of example 19 or 20, where applying the plurality of timing shifts includes applying one or more finite impulse response filters corresponding to the plurality of timing shifts.

Example 22 provides the method of any one of examples 19-21, where determining the plurality of signal metrics includes slicing a candidate signal of the plurality of candidate signals to generate a symbol; forming an error signal based on the candidate signal and the symbol; and determining a mean-squared value of the error signal.

Example 23 provides the method of any one of examples 19-22, where determining the plurality of signal metrics includes determining a timing error of a candidate signal of the plurality of candidate signals.

Example 24 provides the method of any one of examples 19-23, where selecting the selected signal includes determining the selected signal having a minimum signal metric or a maximum signal metric.

Example 25 provides the method of any one of examples 19-24, where selecting the selected signal includes estimating a timing offset based on a curve fitted to the plurality of signal metrics.

Example 26 provides the method of example 25, where selecting the selected signal includes selecting a candidate signal corresponding to the timing offset as the selected signal.

Example 27 provides the method of example 25, where selecting the selected signal includes applying the timing offset to the digital signal using a programmable delay filter to generate the selected signal.

Example 28 provides signal processing logic for reducing equalization-enhanced phase noise of a communication system, the signal processing logic including a plurality of signal paths to receive a digital signal, apply one or more timing offsets to the digital signal, and output a plurality of candidate signals including the digital signal and one or more time-shifted signals, where the digital signal is derived from a coherent signal received over an optical link; a signal assessment logic to determine a plurality of signal metrics for the plurality of candidate signals and output a path selection signal; and a path selector to output a selected candidate signal according to the path selection signal.

Example 29 provides the signal processing logic of example 28, where the plurality of signal paths and the path selector are disposed after a back end processing stage outputting sliced symbols as the digital signal.

Example 30 provides the signal processing logic of example 28, where the plurality of signal paths and the path selector are disposed after a front end processing stage outputting a processed digital signal as the digital signal and before a back end processing stage outputting sliced symbols based on the selected candidate signal.

Example 31 provides the signal processing logic of example 28, where the plurality of signal paths and the path selector are disposed after a least-mean-squared equalizer processing stage outputting an equalized digital signal as the digital signal and before a back end processing stage outputting sliced symbols based on the selected candidate signal.

Example 32 provides the signal processing logic of any one of examples 28-31, further including gating circuitry to selectively disable a subset of the plurality of signal paths.

Example 33 provides the signal processing logic of example 32, where the gating circuitry is controlled by one or more control signals based on one or more of an estimated chromatic dispersion and a link length.

Example 34 provides the signal processing logic of example 32 or 33, where the gating circuitry is controlled by one or more control signals based on a power mode of the communication system.

Example 35 provides the signal processing logic of any one of examples 28-34, where at least one of the one or more timing offsets applied in the plurality of signal paths are programmable by one or more delay control signals.

Example 36 provides the signal processing logic of example 35, where the one or more delay control signals are based on one or more of an estimated chromatic dispersion and a link length.

Example 37 provides the signal processing logic of example 35 or 36, where the one or more delay control signals are based on a timing offset determined based on a curve fitted to the plurality of signal metrics.

Example 38 provides a method for reducing equalization-enhanced phase noise of a communication system, the method including receiving, by a plurality of signal paths, a digital signal; applying, by the plurality of signal paths, one or more timing offsets to the digital signal; outputting, by the plurality of signal paths, a plurality of candidate signals including the digital signal and one or more time-shifted signals, where the digital signal is derived from a coherent signal received over an optical link; determining, by a signal assessment logic, a plurality of signal metrics for the plurality of candidate signals; outputting, by the signal assessment logic, a path selection signal; and outputting, by a path selector, a selected candidate signal according to the path selection signal.

Example 39 provides the method of example 38, where the plurality of signal paths and the path selector are disposed after a back end processing stage outputting sliced symbols as the digital signal.

Example 40 provides the method of example 38, where the plurality of signal paths and the path selector are disposed after a front end processing stage outputting a processed digital signal as the digital signal and before a back end processing stage outputting sliced symbols based on the selected candidate signal.

Example 41 provides the method of example 38, where the plurality of signal paths and the path selector are disposed after a least-mean-squared equalizer processing stage outputting an equalized digital signal as the digital signal and before a back end processing stage outputting sliced symbols based on the selected candidate signal.

Example 42 provides the method of any one of examples 38-41, further including selectively disable, by gating circuitry, a subset of the plurality of signal paths.

Example 43 provides the method of example 42, where the gating circuitry is controlled by one or more control signals based on one or more of an estimated chromatic dispersion and a link length.

Example 44 provides the method of example 42 or 43, where the gating circuitry is controlled by one or more control signals based on a power mode of the communication system.

Example 45 provides the method of any one of examples 38-44, where at least one of the one or more timing offsets applied in the plurality of signal paths are programmable by one or more delay control signals.

Example 46 provides the method of example 45, where the one or more delay control signals are based on one or more of an estimated chromatic dispersion and a link length.

Example 47 provides the method of example 45 or 46, where the one or more delay control signals are based on a timing offset determined based on a curve fitted to the plurality of signal metrics.

Example 48 provides one or more non-transitory computer-readable media storing instructions for reducing equalization-enhanced phase noise of a communication system, that when executed by a processor in the communication system, cause the processor to perform operations including generating a plurality of candidate signals corresponding to a plurality of respective timing offsets for a digital signal derived from a coherent signal received over an optical link; computing a plurality of respective signal metrics for the plurality of candidate signals; and selecting a selected candidate signal from the plurality of candidate signals based on the plurality of signal metrics for subsequent processing.

Example 49 provides the one or more non-transitory computer-readable media of example 48, where computing the plurality of signal metrics includes forming an error signal based on a candidate signal of the plurality of candidate signals and a sliced symbol corresponding to the candidate signal; and determining a mean-squared value of the error signal.

Example 50 provides the one or more non-transitory computer-readable media of example 48 or 49, where computing the plurality of signal metrics includes determining a timing error of a candidate signal of the plurality of candidate signals.

Example 51 provides the one or more non-transitory computer-readable media of any one of examples 48-50, where selecting the selected candidate signal includes determining the selected candidate signal having a minimum signal metric or a maximum signal metric.

Example 52 provides the one or more non-transitory computer-readable media of any one of examples 48-51, where selecting the selected candidate signal includes deriving an estimated timing offset based on a curve fitted to the plurality of signal metrics.

Example 53 provides the one or more non-transitory computer-readable media of example 52, where selecting the selected candidate signal includes selecting a candidate signal from the plurality of candidate signals corresponding to the estimated timing offset as the selected candidate signal.

Example 54 provides the one or more non-transitory computer-readable media of example 52, where selecting the selected candidate signal includes adjusting a delay parameter of a programmable delay filter based on the estimated timing offset to output the selected candidate signal.

Example 55 provides a digital signal processor of a communication system, the digital signal processor to execute instructions implementing blind timing recovery of equalization-enhanced phase noise that cause the digital signal processor to perform operations including generating a plurality of candidate signals corresponding to a plurality of respective timing offsets for a digital signal derived from a coherent signal received over an optical link; computing a plurality of respective signal metrics for the plurality of candidate signals; and selecting a selected candidate signal from the plurality of candidate signals based on the plurality of signal metrics for subsequent processing.

Example 56 provides the digital signal processor of example 55, where computing the plurality of signal metrics includes forming an error signal based on a candidate signal of the plurality of candidate signals and a sliced symbol corresponding to the candidate signal; and determining a mean-squared value of the error signal.

Example 57 provides the digital signal processor of example 55 or 56, where computing the plurality of signal metrics includes determining a timing error of a candidate signal of the plurality of candidate signals.

Example 58 provides the digital signal processor of any one of examples 55-57, where selecting the selected candidate signal includes determining the selected candidate signal having a minimum signal metric or a maximum signal metric.

Example 59 provides the digital signal processor of any one of examples 56-58, where selecting the selected candidate signal includes deriving an estimated timing offset based on a curve fitted to the plurality of signal metrics.

Example 60 provides the digital signal processor of example 59, where selecting the selected candidate signal includes selecting a candidate signal from the plurality of candidate signals corresponding to the estimated timing offset as the selected candidate signal.

Example 61 provides the digital signal processor of example 59, where selecting the selected candidate signal includes adjusting a delay parameter of a programmable delay filter based on the estimated timing offset to output the selected candidate signal.

Example 62 provides a method for reducing equalization-enhanced phase noise of a communication system, the method including generating a plurality of candidate signals corresponding to a plurality of respective timing offsets for a digital signal derived from a coherent signal received over an optical link; computing a plurality of respective signal metrics for the plurality of candidate signals; and selecting a selected candidate signal from the plurality of candidate signals based on the plurality of signal metrics for subsequent processing.

Example 63 provides the method of example 62, where computing the plurality of signal metrics includes forming an error signal based on a candidate signal of the plurality of candidate signals and a sliced symbol corresponding to the candidate signal; and determining a mean-squared value of the error signal.

Example 64 provides the method of example 62 or 63, where computing the plurality of signal metrics includes determining a timing error of a candidate signal of the plurality of candidate signals.

Example 65 provides the method of any one of examples 62-64, where selecting the selected candidate signal includes determining the selected candidate signal having a minimum signal metric or a maximum signal metric.

Example 66 provides the method of any one of examples 63-65, where selecting the selected candidate signal includes deriving an estimated timing offset based on a curve fitted to the plurality of signal metrics.

Example 67 provides the method of example 66, where selecting the selected candidate signal includes selecting a candidate signal from the plurality of candidate signals corresponding to the estimated timing offset as the selected candidate signal.

Example 68 provides the method of example 66, where selecting the selected candidate signal includes adjusting a delay parameter of a programmable delay filter based on the estimated timing offset to output the selected candidate signal.

Example 69 provides a method for blind timing recovery of equalization-enhanced phase noise, the method including processing a received coherent optical signal to produce a digital signal; applying a plurality of timing shifts to the digital signal to form a plurality of timing-shifted signals; determining, for the plurality of timing-shifted signals, a plurality of signal metrics indicative of timing correctness or timing error; and selecting a selected timing-shifted signal based on the plurality of signal metrics for further processing.

Example 70 provides the method of example 69, where determining the plurality of signal metrics includes determining a mean-squared error of a timing-shifted signal of the plurality of timing-shifted signals.

Example 71 provides the method of example 69 or 70, where computing the plurality of signal metrics includes determining a timing error of a timing-shifted signal of the plurality of timing-shifted signals.

Example 72 provides the method of any one of examples 69-71, where selecting the selected timing-shifted signal includes determining the selected timing-shifted signal that has a signal metric indicative of having a highest signal quality among the plurality of timing-shifted signals.

Example 73 provides the method of any one of examples 69-72, where selecting the selected timing-shifted signal includes estimating an optimal timing offset based on a curve fitted to at least a subset of the plurality of signal metrics.

Example 74 provides the method of example 73, where selecting the selected timing-shifted signal includes selecting a timing-shifted signal corresponding to the optimal timing offset as the selected timing-shifted signal.

Example 75 provides the method of example 73, where selecting the selected timing-shifted signal includes adjusting a timing shift of the plurality of timing shifts based on the optimal timing offset to output the selected timing-shifted signal.

Example 76 provides a digital signal processor of a communication system, the digital signal processor to execute instructions implementing blind timing recovery of equalization-enhanced phase noise that causes the digital signal processor to perform operations including processing a received coherent optical signal to produce a digital signal; applying a plurality of timing shifts to the digital signal to form a plurality of timing-shifted signals; determining, for the plurality of timing-shifted signals, a plurality of signal metrics indicative of timing correctness or timing error; and selecting a selected timing-shifted signal based on the plurality of signal metrics for further processing.

Example 77 provides the digital signal processor of example 76, where determining the plurality of signal metrics includes determining a mean-squared error of a timing-shifted signal of the plurality of timing-shifted signals.

Example 78 provides the digital signal processor of example 76 or 77, where computing the plurality of signal metrics includes determining a timing error of a timing-shifted signal of the plurality of timing-shifted signals.

Example 79 provides the digital signal processor of any one of examples 76-78, where selecting the selected timing-shifted signal includes determining the selected timing-shifted signal that has a signal metric indicative of having a highest signal quality among the plurality of timing-shifted signals.

Example 80 provides the digital signal processor of any one of examples 76-79, where selecting the selected timing-shifted signal includes estimating an optimal timing offset based on a curve fitted to at least a subset of the plurality of signal metrics.

Example 81 provides the digital signal processor of example 80, where selecting the selected timing-shifted signal includes selecting a timing-shifted signal corresponding to the optimal timing offset as the selected timing-shifted signal.

Example 82 provides the digital signal processor of example 80, where selecting the selected timing-shifted signal includes adjusting a timing shift of the plurality of timing shifts based on the optimal timing offset to output the selected timing-shifted signal.

Example 83 provides one or more non-transitory computer-readable media storing instructions for blind timing recovery of equalization-enhanced phase noise, that when executed by a processor in a communication system, cause the processor to perform operations including processing a received coherent optical signal to produce a digital signal; applying a plurality of timing shifts to the digital signal to form a plurality of timing-shifted signals; determining, for the plurality of timing-shifted signals, a plurality of signal metrics indicative of timing correctness or timing error; and selecting a selected timing-shifted signal based on the plurality of signal metrics for further processing.

Example 84 provides the one or more non-transitory computer-readable media of example 83, where determining the plurality of signal metrics includes determining a mean-squared error of a timing-shifted signal of the plurality of timing-shifted signals.

Example 85 provides the one or more non-transitory computer-readable media of example 83 or 84, where computing the plurality of signal metrics includes determining a timing error of a timing-shifted signal of the plurality of timing-shifted signals.

Example 86 provides the one or more non-transitory computer-readable media of any one of examples 83-85, where selecting the selected timing-shifted signal includes determining the selected timing-shifted signal that has a signal metric indicative of having a highest signal quality among the plurality of timing-shifted signals.

Example 87 provides the one or more non-transitory computer-readable media of any one of examples 83-86, where selecting the selected timing-shifted signal includes estimating an optimal timing offset based on a curve fitted to at least a subset of the plurality of signal metrics.

Example 88 provides the one or more non-transitory computer-readable media of example 87, where selecting the selected timing-shifted signal includes selecting a timing-shifted signal corresponding to the optimal timing offset as the selected timing-shifted signal.

Example 89 provides the one or more non-transitory computer-readable media of example 87, where selecting the selected timing-shifted signal includes adjusting a timing shift of the plurality of timing shifts based on the optimal timing offset to output the selected timing-shifted signal.

### VARIATIONS AND REMARKS

The detailed description, such as the “Select examples” section, provides various examples of the examples disclosed herein.

As used herein, the term “coupled to” or “coupled with” refers to a relationship between electronic components or circuit elements wherein the components are in electronic communication with one another and are capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. A digital signal processor of a communication system, the digital signal processor to execute instructions implementing blind timing recovery of equalization-enhanced phase noise that cause the digital signal processor to perform operations comprising:
applying a plurality of timing shifts to a digital signal to form a plurality of candidate signals, wherein the digital signal is derived from a coherent signal received over an optical path, and the plurality of candidate signals comprise the digital signal and one or more time-shifted signals;
determining, for the plurality of candidate signals, a plurality of signal metrics; and
selecting a selected signal from the plurality of candidate signals based on the plurality of signal metrics for further signal processing.

2. The digital signal processor of claim 1, wherein applying the plurality of timing shifts comprises:
multiplying the digital signal by one or more phase masks corresponding to the plurality of timing shifts.

3. The digital signal processor of claim 1, wherein applying the plurality of timing shifts comprises:
applying one or more finite impulse response filters corresponding to the plurality of timing shifts.

4. The digital signal processor of claim 1, wherein determining the plurality of signal metrics comprises:
slicing a candidate signal of the plurality of candidate signals to generate a symbol;
forming an error signal based on the candidate signal and the symbol; and
determining a mean-squared value of the error signal.

5. The digital signal processor of claim 1, wherein determining the plurality of signal metrics comprises:
determining a timing error of a candidate signal of the plurality of candidate signals.

6. The digital signal processor of claim 1, wherein selecting the selected signal comprises:
determining the selected signal having a minimum signal metric or a maximum signal metric.

7. The digital signal processor of claim 1, wherein selecting the selected signal comprises:
estimating a timing offset based on a curve fitted to the plurality of signal metrics.

8. The digital signal processor of claim 7, wherein selecting the selected signal comprises:
selecting a candidate signal corresponding to the timing offset as the selected signal.

9. The digital signal processor of claim 7, wherein selecting the selected signal comprises:
applying the timing offset to the digital signal using a programmable delay filter to generate the selected signal.

10. One or more non-transitory computer-readable media storing instructions for reducing equalization-enhanced phase noise of a communication system, that when executed by a processor in the communication system, cause the processor to perform operations comprising:
generating a plurality of candidate signals corresponding to a plurality of respective timing offsets for a digital signal derived from a coherent signal received over an optical link;
computing a plurality of respective signal metrics for the plurality of candidate signals; and
selecting a selected candidate signal from the plurality of candidate signals based on the plurality of signal metrics for subsequent processing.

11. The one or more non-transitory computer-readable media of claim 10, wherein computing the plurality of signal metrics comprises:
forming an error signal based on a candidate signal of the plurality of candidate signals and a sliced symbol corresponding to the candidate signal; and
determining a mean-squared value of the error signal.

12. The one or more non-transitory computer-readable media of claim 10, wherein computing the plurality of signal metrics comprises:
determining a timing error of a candidate signal of the plurality of candidate signals.

13. The one or more non-transitory computer-readable media of claim 10, wherein selecting the selected candidate signal comprises:
determining the selected candidate signal having a minimum signal metric or a maximum signal metric.

14. The one or more non-transitory computer-readable media of claim 10, wherein selecting the selected candidate signal comprises:
deriving an estimated timing offset based on a curve fitted to the plurality of signal metrics.

15. The one or more non-transitory computer-readable media of claim 14, wherein selecting the selected candidate signal comprises:
selecting a candidate signal from the plurality of candidate signals corresponding to the estimated timing offset as the selected candidate signal.

16. The one or more non-transitory computer-readable media of claim 14, wherein selecting the selected candidate signal comprises:
adjusting a delay parameter of a programmable delay filter based on the estimated timing offset to output the selected candidate signal.

17. A method for blind timing recovery of equalization-enhanced phase noise, the method comprising:
processing a received coherent optical signal to produce a digital signal;
applying a plurality of timing shifts to the digital signal to form a plurality of timing-shifted signals;
determining, for the plurality of timing-shifted signals, a plurality of signal metrics indicative of timing correctness or timing error; and
selecting a selected timing-shifted signal based on the plurality of signal metrics for further processing.

18. The method of claim 17, wherein determining the plurality of signal metrics comprises:
determining a mean-squared error of a timing-shifted signal of the plurality of timing-shifted signals.

19. The method of claim 17, wherein computing the plurality of signal metrics comprises:
determining a timing error of a timing-shifted signal of the plurality of timing-shifted signals.

20. The method of claim 17, wherein selecting the selected timing-shifted signal comprises:
determining the selected timing-shifted signal that has a signal metric indicative of having a highest signal quality among the plurality of timing-shifted signals.
